(19) United States
(12) Patent Application Publication
(10) Pub. No.: US 2024/0317988 A1
(43) Pub. Date: Sep. 26, 2024

(54) MONOFUNCTIONAL SILICONE MONOMERS AND SILICONE HYDROGELS FORMED THEREFROM

(71) Applicant: Bausch + Lomb Ireland Limited, Dublin (IE)

(72) Inventors: James Anthony DiBella, Jr., Penfield, NY (US); Wendy G. Ahearn, Rochester, NY (US); Alok Kumar Awasthi, Pittsford, NY (US)

(21) Appl. No.: 18/422,186

(22) Filed: Jan. 25, 2024

Related U.S. Application Data
(60) Provisional application No. 63/453,850, filed on Mar. 22, 2023.

(51) Int. Cl. C08L 43/04; C07F 7/18; C08F 226/08; C08F 230/08

(52) U.S. Cl. CPC C08L 43/04; C07F 7/18; C08F 226/08; C08F 230/08; C08L 2203/02

(57) ABSTRACT

A monofunctional silicone monomer is represented by a structure of Formula I:

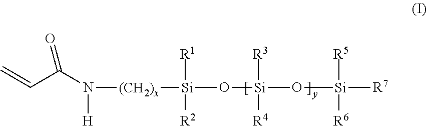

wherein R¹, R², R³, R⁴, R⁵, R⁶, R⁷, x and y are as defined herein. An ophthalmic device having optical clarity is a polymerization product of a monomeric mixture includes (a) one or more of the monofunctional silicone monomers represented by a structure of Formula I, and (b) one or more ophthalmic device-forming hydrophilic comonomers.

### PRIORITY CLAIM

The present application claims priority to U.S. Provisional Patent Application Ser. No. 63/453,850, entitled “Monofunctional Silicone Monomers and Silicone Hydrogels Formed Therefrom,” filed Mar. 22, 2023, the content of which is incorporated by reference herein in its entirety.

### BACKGROUND

In the field of biomedical devices such as contact lenses, various physical and chemical properties such as, for example, optical clarity, oxygen permeability, wettability, material strength and stability are but a few of the factors that must be carefully balanced in order to provide a useable contact lens. For example, since the cornea receives its oxygen supply exclusively from contact with the atmosphere, good oxygen permeability is a critical characteristic for any contact lens material. Wettability also is important in that, if the lens is not sufficiently wettable, it does not remain lubricated and therefore cannot be worn comfortably in the eye. Accordingly, the optimum contact lens would have at least both excellent oxygen permeability and excellent tear fluid wettability.

Hydrogels represent a desirable class of materials for many biomedical applications, including contact lenses and intraocular lenses. Hydrogels are hydrated, crosslinked polymeric systems that contain water in an equilibrium state. Silicone hydrogels are a known class of hydrogels and are characterized by the inclusion of a silicone-containing material. Typically, a silicone-containing monomer is copolymerized by free radical polymerization with a hydrophilic monomer, with either the silicone-containing monomer or the hydrophilic monomer functioning as a crosslinking agent (a crosslinker being defined as a monomer having multiple polymerizable functionalities) or a separate crosslinker may be employed. An advantage of silicone hydrogels over non-silicone hydrogels is that the silicone hydrogels typically have higher oxygen permeability due to the inclusion of the silicone-containing monomer.

### SUMMARY

In accordance with an illustrative embodiment, a monofunctional silicone monomer is represented by a structure of Formula I:

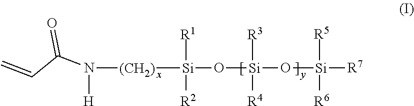

wherein R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aryl group and a C₆ to C₁₂ heteroaryl group; R⁵, R⁶ and R⁷ are independently a straight or branched C₁ to C₁₂ alkyl group, x is from 1 to 6, and y is from 3 to 5.

In accordance with another illustrative embodiment, an ophthalmic device which is a polymerization product of a monomeric mixture comprising:
(a) one or more monofunctional silicone monomers represented by a structure of Formula I:

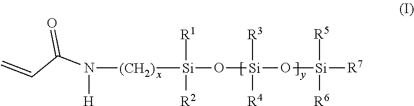

wherein R¹, R², R³, R⁴, R⁵, R⁶, R⁷, x and y are as defined herein, and
(b) one or more ophthalmic device-forming hydrophilic comonomers.

In accordance with still yet another illustrative embodiment, an ophthalmic device which is a polymerization product of a monomeric mixture comprising:
(a) one or more monofunctional silicone monomers represented by a structure of Formula I:

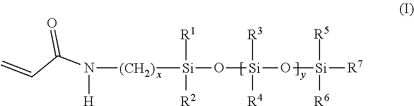

wherein R¹, R², R³, R⁴, R⁵, R⁶, R⁷, x and y are as defined herein,
(b) one or more ophthalmic device-forming hydrophilic comonomers, and
(c) one or more non-functional comfort polymers.

In accordance with still yet a further illustrative embodiment, a method for making an ophthalmic device comprises:
(a) curing a monomeric mixture in a mold, the monomeric mixture comprising:
(i) one or more monofunctional silicone monomers represented by a structure of Formula I:

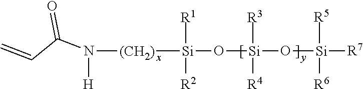

wherein R¹, R², R³, R⁴, R⁵, R⁶, R⁷, x and y are as defined herein, and
(ii) one or more ophthalmic device-forming hydrophilic comonomers, and
(b) dry releasing the ophthalmic device from the mold.

### DETAILED DESCRIPTION

Various illustrative embodiments described herein are directed to silicone monomers and their use in forming ophthalmic devices such as silicon hydrogels having improved optical clarity. Silicone hydrogels (SiHy) such as contact lenses, which are made of a hydrated, crosslinked polymeric material that contains silicone and a certain amount of water within the lens polymer matrix at equilibrium, are increasingly becoming popular, because they have minimal adverse effects on corneal health due to their high oxygen permeability. However, incorporation of silicone in a contact lens material can have undesirable effects on the hydrophilicity and wettability of silicone hydrogels, because silicone is hydrophobic and has a great tendency to migrate onto the lens surface being exposed to air. Contact lens manufacturers have therefore made a great effort in developing SiHy contact lenses having a hydrophilic and wettable surface.

One approach to modifying the hydrophilicity and wettability of a SiHy contact lens is to add a hydrophilic monomer to the monomeric mixture in forming the SiHy contact lens. However, it has been found that adding monofunctional silicone monomers to a monomeric mixture containing one or more ophthalmic device-forming hydrophilic monomers may result in phase separation of the resulting monomeric mixture during polymerization.

Another approach is the incorporation of monomeric wetting/comfort agents such as non-functionalized comfort polymers, e.g., high molecular weight hydrophilic polymer(s) (e.g., polyvinylpyrrolidone (PVP)) in the monomeric mixtures for forming interpenetrating networks in a lens formulation for making naturally-wettable SiHy contact lens (i.e., wettable SiHy lenses without post-molding surface treatment). However, not all silicone containing monomers display compatibility with the high molecular hydrophilic polymers. For example, while it may be possible to incorporate the high molecular weight hydrophilic polymers as internal wetting/comfort agents into silicone hydrogel lenses, such polymers can be difficult to solubilize in reaction mixtures which contain silicone containing monomers and hydrophilic monomers such as vinyl lactams. Generally, higher amounts of the internal wetting/comfort agents such as PVP are desirable to ensure that the lens has a wettable and lubricious surface. However, when formulating a monomeric mixture containing a non-functionalized comfort polymer such as PVP in an amount of at least 6 wt. %, based on the total weight of the monomeric mixture, with a silicone monomer represented by a structure of Formula I where y is greater than 5 the reaction mixtures will result in a cloudy mix during polymerization thereby leading to an optically unclear lens.

The illustrative embodiments described herein overcome the foregoing drawbacks by using one or more of the monofunctional silicone monomers represented by the structure of Formula I to form an ophthalmic device such as a SiHy contact lens having improved properties such as hydrophilicity and wettability and optical clarity. The one or more monofunctional silicone monomers represented by the structure of Formula I are compatible with the ophthalmic device-forming hydrophilic monomers in the monomeric mixtures. In addition, the one or more monofunctional silicone monomers represented by the structure of Formula I also assist in solubilizing the non-functionalized comfort polymers such as PVP when present in a monomeric mixture containing the non-functionalized comfort polymer in an amount of at least 6 wt. %, based on the total weight of the monomeric mixture, thereby forming an ophthalmic device such as a silicone hydrogel having a wettable and lubricious surface as well as improved optical clarity.

As used herein, the term “SiHy” shall be understood to mean silicone hydrogel.

As used herein, the term “hydrogel” or “hydrogel material” refers to a crosslinked polymeric material that has three-dimensional polymer networks (i.e., polymer matrix), is insoluble in water, but can hold at least 10 percent by weight of water in its polymer matrix when it is fully hydrated.

As used herein, the term “silicone hydrogel” or “SiHy” interchangeably refers to a hydrogel containing silicone. A silicone hydrogel (SiHy) typically is obtained by copolymerization of a polymerizable composition comprising at least one silicone-containing vinylic monomer or at least one silicone-containing vinylic macromer or at least one silicone-containing prepolymer having ethylenically unsaturated groups.

As used herein, the term “(meth)” denotes an optional methyl substituent. Thus, terms such as “(meth)acrylate” denotes either methacrylate or acrylate, and “(meth)acrylamide” denotes either methacrylamide or acrylamide.

In accordance with non-limiting illustrative embodiments, a monofunctional silicone monomer for use in forming the ophthalmic devices described herein is represented by a structure of Formula I:

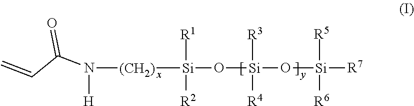

wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 5.

In one embodiment, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 5.

In one embodiment, R¹, R², R³ and R⁴ are independently hydrogen, a C₁ to C₆ alkyl group; R⁵, R⁶ and R⁷ are independently a straight or branched C₁ to C₆ alkyl group; x is from 1 to 6; and y is from 3 to 5.

In one embodiment, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 5.

Representative examples of alkyl groups for use herein include, by way of example, a straight or branched alkyl chain radical containing carbon and hydrogen atoms of from 1 to about 30 carbon atoms or from 1 to about 12 carbon atoms or from 1 to about 6 carbon atoms with or without unsaturation, to the rest of the molecule, e.g., methyl, ethyl, n-propyl, 1-methylethyl (isopropyl), n-butyl, n-pentyl, methylene, ethylene, etc., and the like, optionally containing one or more heteroatoms, e.g., O and N, and the like, or one or more halogen atoms, e.g., fluorine, chlorine, bromine, and iodine, to form a halo alkyl group.

Representative examples of cycloalkyl groups for use herein include, by way of example, a substituted or unsubstituted, non-aromatic mono or multicyclic ring system of about 3 to about 30 carbon atoms or from 3 to about 12 carbon atoms or from 3 to about 6 carbon atoms such as, for example, cyclopropyl, cyclobutyl, cyclopentyl, cyclohexyl, perhydronapththyl, adamantyl and norbornyl groups, bridged cyclic groups or sprirobicyclic groups, e.g., spiro-(4, 4)-non-2-yl and the like, optionally containing one or more heteroatoms, e.g., O and N, and the like to form a heterocycloalkyl group.

Representative examples of cycloalkylalkyl groups for use herein include, by way of example, a substituted or unsubstituted, cyclic ring-containing radical containing from about 4 to about 30 carbon atoms or from 3 to about 6 carbon atoms directly attached to the alkyl group which are then attached to the main structure of the monomer at any carbon from the alkyl group that results in the creation of a stable structure such as, for example, cyclopropylmethyl, cyclobutylethyl, cyclopentylethyl and the like, wherein the cyclic ring can optionally contain one or more heteroatoms, e.g., O and N, and the like to form a heterocycloalkylalkyl group.

Representative examples of cycloalkenyl groups for use herein include, by way of example, a substituted or unsubstituted cyclic ring-containing radical containing from about 3 to about 30 carbon atoms or from 3 to about 6 carbon atoms with at least one carbon-carbon double bond such as, for example, cyclopropenyl, cyclobutenyl, cyclopentenyl and the like, wherein the cyclic ring can optionally contain one or more heteroatoms, e.g., O and N, and the like to form a heterocycloalkenyl group.

Representative examples of aryl groups for use herein include, by way of example, a substituted or unsubstituted, monoaromatic or polyaromatic radical containing from about 6 to about 30 carbon atoms or from about 6 to about 12 carbon atoms such as, for example, phenyl, naphthyl, tetrahydronapthyl, indenyl, biphenyl and the like, optionally containing one or more heteroatoms, e.g., O and N, and the like to form a heteroaryl group.

In an illustrative embodiment, the monofunctional silicone monomer represented by the structure of Formula I disclosed herein can be prepared according to the following reaction Scheme I.

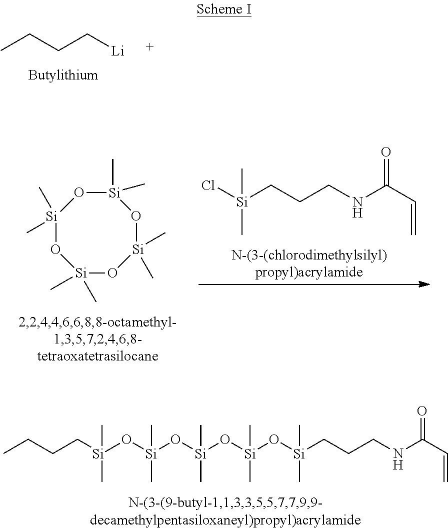

As stated above, the monofunctional silicone monomer represented by the structure of Formula I disclosed herein is useful in forming ophthalmic devices having improved optical clarity. As used herein, the term “ophthalmic device” refers to ophthalmic devices that reside in or on the eye. These devices can provide optical correction, wound care, drug delivery, diagnostic functionality or cosmetic enhancement or effect or a combination of these properties. Suitable ophthalmic devices include, for example, ophthalmic lenses such as soft contact lenses, e.g., a soft, hydrogel lens; soft, non-hydrogel lens and the like, hard contact lenses, e.g., a hard, gas permeable lens material and the like, intraocular lenses, overlay lenses, ocular inserts, optical inserts and the like. As is understood by one skilled in the art, a lens is considered to be “soft” if it can be folded back upon itself without breaking.

In accordance with one or more additional non-limiting illustrative embodiments, as may be combined with one or more of the preceding paragraphs, an ophthalmic device is a polymerization product of a monomeric mixture which comprises:
(a) one or more monofunctional silicone monomers represented by a structure of Formula I:

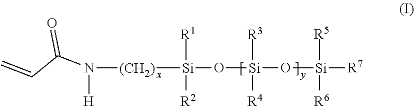

wherein R¹, R², R³, R⁴, R⁵, R⁶, R⁷, x and y are as defined herein; and
(b) one or more ophthalmic device-forming hydrophilic comonomers.

The one or more monofunctional silicone monomers represented by a structure of Formula I as disclosed herein can be present in the monomeric mixture in an amount ranging from about 1 wt. % to about 40 wt. %, based on the total weight of the monomeric mixture. In some embodiments, the one or more silicone monomers represented by a structure of Formula I as disclosed herein can be present in the monomeric mixture in an amount ranging from about 1 wt. % to about 35 wt. %, based on the total weight of the monomeric mixture. In another illustrative embodiment, the one or more silicone monomers represented by a structure of Formula I as disclosed herein can be present in the monomeric mixture in an amount ranging from about 5 wt. % to about 40 wt. %, based on the total weight of the monomeric mixture. In another illustrative embodiment, the one or more silicone monomers represented by a structure of Formula I as disclosed herein can be present in the monomeric mixture in an amount ranging from about 5 wt. % to about 20 wt. %, based on the total weight of the monomeric mixture.

Suitable ophthalmic device-forming hydrophilic comonomers as component (b) include, for example, unsaturated carboxylic acids, acrylamides, vinyl lactams, hydroxyl-containing-(meth)acrylates, hydrophilic vinyl carbonates, hydrophilic vinyl carbamates, hydrophilic oxazolones, and poly(alkene glycols) functionalized with polymerizable groups and the like and mixtures thereof. Representative examples of unsaturated carboxylic acids include, but are not limited to, methacrylic acid, acrylic acid and the like and mixtures thereof. Representative examples of acrylamides include, but are not limited to, alkylamides such as N,N-dimethylacrylamide, N,N-dimethylmethacrylamide and the like and mixtures thereof. Representative examples of cyclic lactams include, but are not limited to, N-vinyl-2-pyrrolidone, N-vinyl caprolactam, N-vinyl-2-piperidone and the like and mixtures thereof. Representative examples of hydroxyl-containing (meth)acrylates include, but are not limited to, 2-hydroxyethyl methacrylate (HEMA), glycerol methacrylate and the like and mixtures thereof. Additional ophthalmic device-forming hydrophilic comonomers include, for example, the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable ophthalmic device-forming hydrophilic comonomers will be apparent to one skilled in the art. Mixtures of the foregoing ophthalmic device-forming hydrophilic comonomers can also be used in the monomeric mixtures herein.

In accordance with one or more additional non-limiting illustrative embodiments, as may be combined with one or more of the preceding paragraphs, the one or more ophthalmic device-forming hydrophilic comonomers can be present in the monomeric mixture in an amount ranging from about 10 wt. % to about 80 wt. %, based on the total weight of the monomeric mixture. In another illustrative embodiment, the one or more ophthalmic device-forming hydrophilic comonomers can be present in the monomeric mixture in an amount ranging from about 20 wt. % to about 80 wt. %, based on the total weight of the monomeric mixture. In another illustrative embodiment, the one or more ophthalmic device-forming hydrophilic comonomers can be present in the monomeric mixture in an amount ranging from about 10 wt. % to about 50 wt. %, based on the total weight of the monomeric mixture.

In non-limiting illustrative embodiments, as may be combined with one or more of the preceding paragraphs, the monomeric mixture can further contain one or more non-functionalized comfort polymers. In non-limiting illustrative embodiments, the one or more non-functionalized comfort polymers include, for example, a polyvinylpyrrolidone (PVP) polymer. PVP is a linear homopolymer or essentially a linear homopolymer comprising at least 90% repeat units derived from 1-vinyl-2-pyrrolidone monomer, the remainder of the monomer composition can include neutral monomer, e.g., vinyl or acrylates. Other synonyms for PVP include povidone, polyvidone, 1-vinyl-2-pyrrolidinone, and 1-ethenyl-2-pyrrolidone. In an illustrative embodiment, the PVP can have a weight average molecular weight of at least about 10,000, e.g., from about 10,000 to about 250,000 or from about 30,000 to about 100,000. The weight average molecular weight of PVP can be determined by gel permeation chromatography. Such materials are sold by various sources such as, for example, ISP Technologies, Inc. under the trademark PLASDONE®K-29/32, from BASF under the trademark KOLLIDON®, for example, KOLLIDON® K-30 or K-90.

In accordance with one or more additional non-limiting illustrative embodiments, as may be combined with one or more of the preceding paragraphs, the one or more non-functionalized comfort polymers can be present in the monomeric mixture in an amount of at least 6 wt. %, based on the total weight of the monomeric mixture. In one embodiment, the one or more non-functionalized comfort polymers can be present in the monomeric mixture in an amount ranging from 6 wt. % to about 10 wt. %, based on the total weight of the monomeric mixture.

In non-limiting illustrative embodiments, as may be combined with one or more of the preceding paragraphs, the monomeric mixture can further contain one or more functionalized comfort polymers. In non-limiting illustrative embodiments, the one or more functionalized comfort polymers include, for example, a functionalized poloxamer, a functionalized poloxamine and mixtures thereof. A functionalized poloxamer is derived from a poloxamer block copolymer. One specific class of poloxamer block copolymers are those available under the trademark Pluronic (BASF Wyandotte Corp., Wyandotte, Mich.). Poloxamers include Pluronics and reverse Pluronics. Pluronics are a series of ABA block copolymers composed of poly(ethylene oxide)-poly(propylene oxide)-poly(ethylene oxide) blocks as generally represented by the structure:

HO(C₂H₄O)ₐ(C₃H₆O)_{b}(C₂H₄O)ₐH

wherein a is independently at least 1 and b is at least 1.

Reverse Pluronics are a series of BAB block copolymers, respectively composed of poly(propylene oxide)-poly(ethylene oxide)-poly(propylene oxide) blocks as generally represented by the structure:

HO(C₃H₆O)_{b}(C₂H₄O)ₐ(C₃H₆O)_{b}H

wherein a is at least 1 and b is independently at least 1. The poly(ethylene oxide), PEO, blocks are hydrophilic, whereas the poly(propylene oxide), PPO, blocks are hydrophobic in nature. The poloxamers in each series have varying ratios of PEO and PPO which ultimately determines the hydrophilic-lipophilic balance (HLB) of the material, i.e., the varying HLB values are based upon the varying values of a and b, a representing the number of hydrophilic poly(ethylene oxide) units (PEO) being present in the molecule and b representing the number of hydrophobic poly(propylene oxide) units (PPO) being present in the molecule. In one embodiment, the poloxamer will have an HLB ranging from about 5 to about 24. In another embodiment, the poloxamer will have an HLB ranging from about 1 to about 5.

Poloxamers and reverse poloxamers have terminal hydroxyl groups that can be terminal functionalized to form the functionalized poloxamer. An example of a terminal functionalized poloxamer as discussed herein is poloxamer dimethacrylate (e.g., Pluronic® F127 dimethacrylate) as disclosed in U.S. Patent Application Publication No. 2003/0044468 and U.S. Pat. No. 9,309,357, the contents of which are incorporated by reference herein. Other examples include glycidyl-terminated copolymers of polyethylene glycol and polypropylene glycol as disclosed in U.S. Pat. No. 6,517,933, the contents of which are incorporated by reference herein.

The poloxamer is functionalized to provide the desired reactivity at the end terminal of the molecule. The functionality can be varied and is determined based upon the intended use of the functionalized PEO- and PPO-containing block copolymers. That is, the PEO- and PPO-containing block copolymers are reacted to provide end terminal functionality that is complementary with the intended device forming monomeric mixture. The term block copolymer as used herein shall be understood to mean a poloxamer as having two or more blocks in their polymeric backbone(s). In non-limiting illustrative embodiments, a functionalized poloxamer is a poloxamer di(meth)acrylate, a reverse poloxamer di(meth)acrylate and mixtures thereof.

While the poloxamers and reverse poloxamers are considered to be difunctional molecules (based on the terminal hydroxyl groups), the poloxamines are in a tetrafunctional form, i.e., the molecules are tetrafunctional block copolymers terminating in primary hydroxyl groups and linked by a central diamine. One specific class of poloxamine block copolymers are those available under the trademark Tetronic (BASF). Poloxamines include Tetronic and reverse Tetronics. Poloxamines have the following general structure:

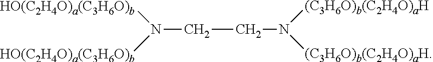

wherein a is independently at least 1 and b is independently at least 1.

The poloxamine can be functionalized to provide the desired reactivity at the end terminal of the molecule. The functionality can be varied and is determined based upon the intended use of the functionalized PEO- and PPO-containing block copolymers. That is, the PEO- and PPO-containing block copolymers are reacted to provide end terminal functionality that is complementary with the intended ophthalmic device forming monomeric mixture. The term block copolymer as used herein shall be understood to mean a poloxamine as having two or more blocks in their polymeric backbone(s).

In an illustrative embodiment, the one or more functionalized comfort polymers are present in the monomeric mixture in an amount ranging from about 1 to about 10 wt. %, based on the total weight of the monomeric mixture. In another illustrative embodiment, the one or more functionalized comfort polymers are present in the monomeric mixture in an amount ranging from about 2 to about 7 wt. %, based on the total weight of the monomeric mixture.

In non-limiting illustrative embodiments, as may be combined with one or more of the preceding paragraphs, the monomeric mixture can further contain one or more ophthalmic device-forming silicone comonomers in addition to the one or more monofunctional silicone monomers represented by a structure of Formula I. Representative ophthalmic device-forming silicone comonomers for use in the formation of, for example, silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995. Specific examples of suitable materials for use herein include those disclosed in U.S. Pat. Nos. 5,310,779; 5,387,662; 5,449,729; 5,512,205; 5,610,252; 5,616,757; 5,708,094; 5,710,302; 5,714,557 and 5,908,906, the contents of which are incorporated by reference herein.

In an illustrative embodiment, as may be combined with one or more of the preceding paragraphs, the one or more ophthalmic device-forming silicone comonomers can include, as a class of representative ophthalmic device-forming silicone comonomers, one or more non-bulky organosilicon-containing monomers. An “organosilicon-containing monomer” as used herein contains at least one [siloxanyl] or at least one [silyl-alkyl-siloxanyl]repeating unit, in a monomer, macromer or prepolymer. In an illustrative embodiment, an example of a non-bulky organosilicon-containing monomer is represented by a structure of Formula IIa:

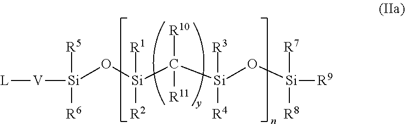

wherein L is an ethylenically unsaturated polymerizable group, V is a linker group or a bond; R¹, R², R³, R⁴, R⁵, R⁶, R⁷, R⁸, and R⁹ are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R¹⁰ and R¹¹ is hydrogen; y is 2 to 7 and n is 1 to 100 or from 1 to 20.

Ethylenically unsaturated polymerizable groups are well known to those skilled in the art. Suitable ethylenically unsaturated polymerizable groups include, for example, (meth)acrylates, vinyl carbonates, O-vinyl carbamates, N-vinyl carbamates, and (meth)acrylamides.

Linker groups can be any divalent radical or moiety and include, for example, substituted or unsubstituted C₁ to C₁₂ alkyl group, an alkyl ether group, an alkenyl group, an alkenyl ether group, a halo alkyl group, a substituted or unsubstituted siloxane group, and monomers capable of propagating ring opening.

In one embodiment, V is a (meth)acrylate, L is a C₁ to C₁₂ alkylene group, R¹, R², R³, R⁴, R⁵, R⁶, R⁷, R⁸, and R⁹ are independently a C₁ to C₁₂ alkyl group, R¹⁰ and R¹¹ are independently H or a C₁ to C₁₂ alkyl group, y is 2 to 7 and n is 3 to 8.

In one embodiment, V is a (meth)acrylate, L is a C₁ to C₆ alkyl group, R¹, R², R³, R⁴, R⁵, R⁶, R⁷, R⁸, and R⁹ are independently a C₁ to C₆ alkyl group, R¹⁰ and R¹¹ are independently H or a C₁ to C₆ alkyl group, y is 2 to 7 and n is 1 to 20.

Non-bulky organosilicon-containing monomers represented by a structure of Formula IIa are known in the art, see, e.g., U.S. Pat. Nos. 7,915,323, 7,994,356, 8,420,711, 8,827,447 and 9,039,174, the contents of which are incorporated by reference herein.

In an illustrative embodiment, as may be combined with one or more of the preceding paragraphs, the one or more non-bulky organosilicon-containing monomers can also comprise a compound represented by a structure of Formula IIb:

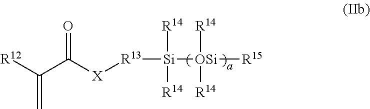

wherein R¹² is H or methyl; X is O or NR¹⁶; wherein R¹⁶ is selected from H, or C₁ to C₄ alkyl, which may be further substituted with one or more hydroxyl groups, and in some embodiments is H or methyl; R¹³ is a divalent alkyl group, which may further be functionalized with a group selected from the group consisting of ether groups, hydroxyl groups, carbamate groups and combinations thereof, and in another embodiment a C₁ to C₆ alkylene group which may be substituted with ether, hydroxyl and combinations thereof, and in yet another embodiment a C₁ or C₃ to C₄ alkylene group which may be substituted with ether, hydroxyl and combinations thereof; each R¹⁴ is independently a phenyl or a C₁ to C₄ alkyl group which may be substituted with fluorine, hydroxyl or ether, and in another embodiment each R¹⁴ is independently selected from ethyl and methyl groups, and in yet another embodiment, each R¹⁴ is methyl; R¹⁵ is a C₁ to C₄ alkyl group; a is 2 to 50, and in some embodiments 5 to 15.

Non-bulky organosilicon-containing monomers represented by a structure of Formula IIb are known in the art, see, e.g., U.S. Pat. Nos. 8,703,891, 8,937,110, 8,937,111, 9,156,934 and 9,244,197, the contents of which are incorporated by reference herein.

In an illustrative embodiment, as may be combined with one or more of the preceding paragraphs, the one or more ophthalmic device-forming silicone comonomers can include, as a class of representative ophthalmic device-forming silicone comonomers, one or more bulky silicone-containing monomers. In an embodiment, suitable bulky silicone-containing monomers include, for example, a bulky polysiloxanylalkyl (meth)acrylic monomer, a bulky polysiloxanylalkyl carbamate monomer and mixtures thereof. A representative example of a bulky silicone-containing monomer includes a bulky polysiloxanylalkyl(meth)acrylic monomer is represented by a structure of Formula III:

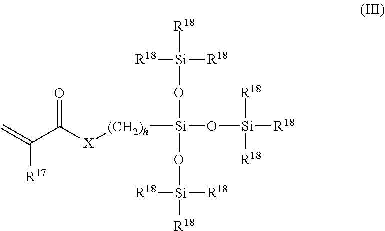

wherein X denotes —O— or —NR¹⁹—, where each R¹⁹ is hydrogen or a C₁-C₄ alkyl group; R¹⁷ independently denotes hydrogen or methyl; each R¹⁸ independently denotes a lower alkyl radical such as a C₁-C₆ group, a phenyl radical or a group represented by the following structure:

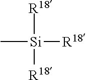

wherein each R^{18′} independently denotes a lower alkyl radical or a phenyl radical; and h is 1 to 10; or a bulky silicone-containing monomer represented by a structure of Formula IV:

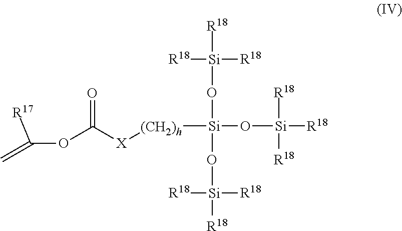

wherein X denotes —NR¹⁹— wherein R¹⁹ denotes hydrogen or a C₁-C₄ alkyl; R¹⁷ denotes hydrogen or methyl; each R¹⁸ independently denotes a lower alkyl radical, a phenyl radical or a group represented by the following structure:

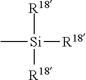

wherein each R^{18′} independently denotes a lower alkyl radical or a phenyl radical; and h is 1 to 10.

Representative examples of bulky silicone-containing monomers include 3-methacryloyloxypropyltris(trimethyl-siloxy)silane or tris(trimethylsiloxy)silylpropyl methacrylate, sometimes referred to as TRIS and tris(trimethylsiloxy)silylpropyl vinyl carbamate, sometimes referred to as TRIS-VC, pentamethyldisiloxanyl methylmethacrylate, phenyltetramethyl-disiloxanylethyl acetate, and methyldi(trimethylsiloxy)methacryloxymethyl silane, (3-methacryloxy-2-hydroxy propoxy)propyl bis(trimethyl siloxy)methyl silane, sometimes referred to as Sigma and the like and mixtures thereof. In one embodiment, the bulky silicone-containing monomer is a tris(trialkylsiloxy)silylalkyl methacrylate-containing monomer such as a tris(trimethylsiloxy)silylpropyl methacrylate-containing monomer.

Such bulky monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

In an illustrative embodiment, as may be combined with one or more of the preceding paragraphs, the one or more ophthalmic device-forming silicone comonomers can include, as a class of representative ophthalmic device-forming silicone comonomers, one or more silicone-containing vinyl carbonates or vinyl carbamate monomers. Suitable one or more silicone-containing vinyl carbonate or vinyl carbamate monomers include, for example, 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

In an illustrative embodiment, as may be combined with one or more of the preceding paragraphs, the one or more ophthalmic device-forming silicone comonomers can include, as a class of representative ophthalmic device-forming silicone comonomers, one or more polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae V and VI:

E(*D*A*D*G)ₐ*D*A*D*E′; or (V)

E(*D*G*D*A)ₐ*D*A*D*E′; or (VI)

wherein:

D independently denotes an alkyl diradical, an alkyl cycloalkyl diradical, a cycloalkyl diradical, an aryl diradical or an alkylaryl diradical having 6 to about 30 carbon atoms;

G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;

* denotes a urethane or ureido linkage;

a is at least 1;

A independently denotes a divalent polymeric radical of Formula VII:

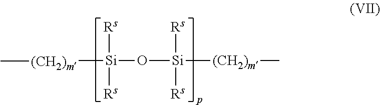

wherein each R^{s} independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula VIII:

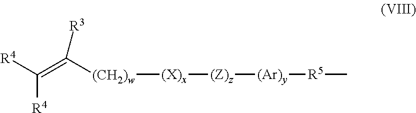

wherein: R³ is hydrogen or methyl;
R⁴ is hydrogen, an alkyl radical having 1 to 6 carbon atoms, or a —CO—Y—R⁶ radical wherein Y is —O—, —S— or —NH—;
R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

In an illustrative embodiment, as may be combined with one or more of the preceding paragraphs, the one or more ophthalmic device-forming silicone comonomers can include, as a class of representative ophthalmic device-forming silicone comonomers, one or more silicone-containing urethane monomers represented by Formula IX:

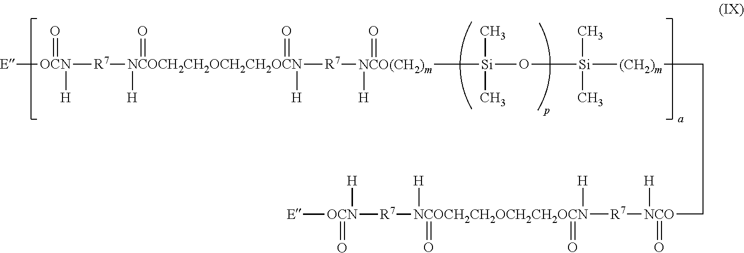

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

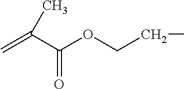

In another embodiment, a silicone hydrogel material comprises (in bulk, that is, in the monomer mixture that is copolymerized) about 5 to about 50 percent, or from about 10 to about 25, by weight of one or more silicone macromonomers, about 5 to about 75 percent, or about 30 to about 60 percent, by weight of one or more polysiloxanylalkyl (meth)acrylic monomers, and about 10 to about 50 percent, or about 20 to about 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 discloses additional unsaturated groups, including acryloxy or methacryloxy. Fumarate-containing materials such as those disclosed in U.S. Pat. Nos. 5,310,779; 5,449,729 and 5,512,205 are also useful substrates in accordance with the non-limiting embodiments described herein. The silane macromonomer may be a silicone-containing vinyl carbonate or vinyl carbamate or a polyurethane-polysiloxane having one or more hard-soft-hard blocks and end-capped with a hydrophilic monomer.

In an illustrative embodiment, as may be combined with one or more of the preceding paragraphs, the one or more ophthalmic device-forming silicone comonomers can include, as a class of representative ophthalmic device-forming silicone comonomers, one or more monomers of Formula X:

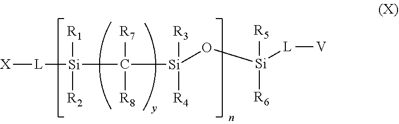

wherein X is the residue of a ring opening agent; L is the same or different and is a linker group or a bond; V is an ethylenically unsaturated polymerizable group; R₁, R₂, R₃, R₄, R₅, R₆ are independently hydrogen, an alkyl group, a haloalkyl group, a cycloalkyl group, a heterocycloalkyl group, an alkenyl group, a halo alkenyl group, or an aromatic group; R₇ and R₈ are independently hydrogen or an alkyl group wherein at least one of R₇ or R₈ is hydrogen; y is 2-7 and n is 1-100.

Ring opening agents are well known in the literature. Non-limiting examples of anionic ring opening agents include alkyl lithium, an alkoxide, trialkylsiloxylithium wherein the alkyl group may or may not contain halo atoms.

Linker groups can be any divalent radical or moiety and include substituted or unsubstituted alkyl, alkyl ether, alkenyls, alkenyl ethers, halo alkyls, substituted or unsubstituted siloxanes, and monomers capable of propagating ring opening.

Ethylenically unsaturated polymerizable groups are well known to those skilled in the art. Non-limiting examples of ethylenically unsaturated polymerizable groups would include acrylates, methacrylates, vinyl carbonates, O-vinyl carbamates, N-vinyl carbamates, acrylamides and methacrylamides.

In an illustrative embodiment, as may be combined with one or more of the preceding paragraphs, the one or more ophthalmic device-forming silicone comonomers can include, as a class of representative ophthalmic device-forming silicone comonomers, one or more monomers of Formula XI:

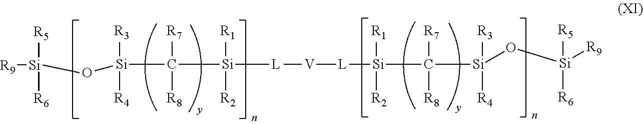

wherein L is the same or different and is a linker group or a bond; V is the same or different and is an ethylenically unsaturated polymerizable group; R₁, R₂, R₃, R₄, R₅, R₆ and R₉ are independently hydrogen, an alkyl group, a haloalkyl group, a cycloalkyl group, a heterocycloalkyl group, an alkenyl group, a halo alkenyl group, or an aromatic group; R₇ and R₈ are independently hydrogen or an alkyl group wherein at least one of R₇ or R₈ is hydrogen; y is 2-7 and n is 1-100.

In an illustrative embodiment, as may be combined with one or more of the preceding paragraphs, the one or more ophthalmic device-forming silicone comonomers can include, as a class of representative ophthalmic device-forming silicone comonomers, one or more monomers of Formulae XII and XIII:

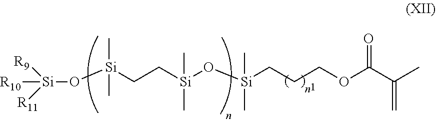

wherein R₉, R₁₀ and R₁₁ are independently hydrogen, an alkyl group, a haloalkyl group or other substituted alkyl groups; n is as defined above and n¹ is 0-10; and,

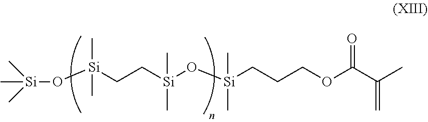

wherein n is 1 to 100, or n is 2 to 80, or n is 3 to 20, or n is 5 to 15.

In an illustrative embodiment, as may be combined with one or more of the preceding paragraphs, the one or more ophthalmic device-forming silicone comonomers can include, as a class of representative ophthalmic device-forming silicone comonomers, one or more monomers of Formulas XIV-XVIII:

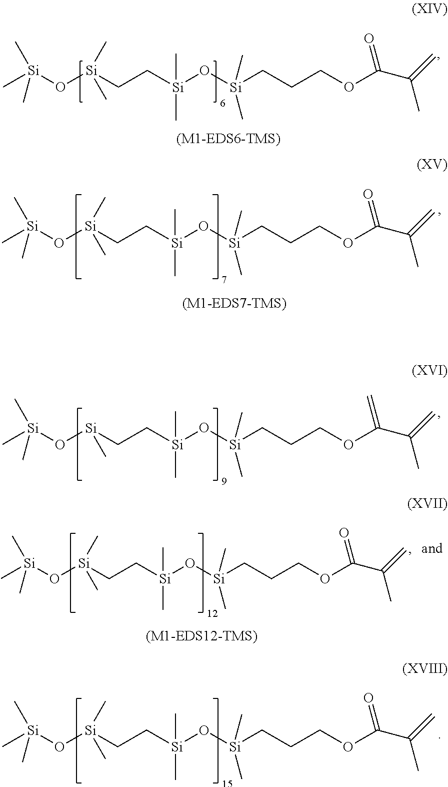

In an illustrative embodiment, as may be combined with one or more of the preceding paragraphs, the one or more ophthalmic device-forming silicone comonomers can include, as a class of representative ophthalmic device-forming silicone comonomers, one or more monomers of Formulas XIX-XXI:

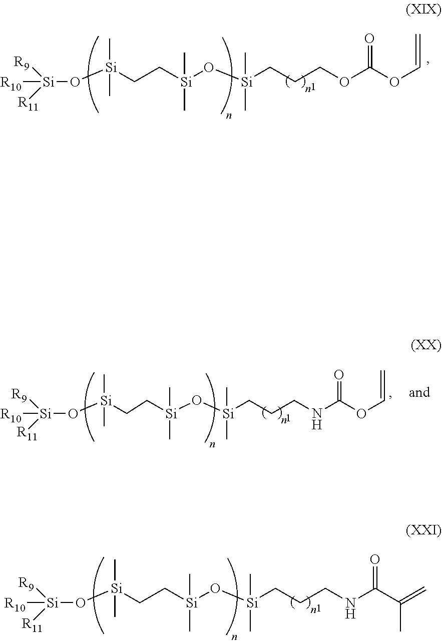

wherein R₉, R₁₀ and R₁₁ are independently hydrogen, an alkyl group, a haloalkyl group or other substituted alkyl groups and n and n¹ are as defined above.

In an illustrative embodiment, as may be combined with one or more of the preceding paragraphs, the one or more ophthalmic device-forming silicone comonomers can include, as a class of representative ophthalmic device-forming silicone comonomers, one or more monomers of Formulas XXII-XXIV:

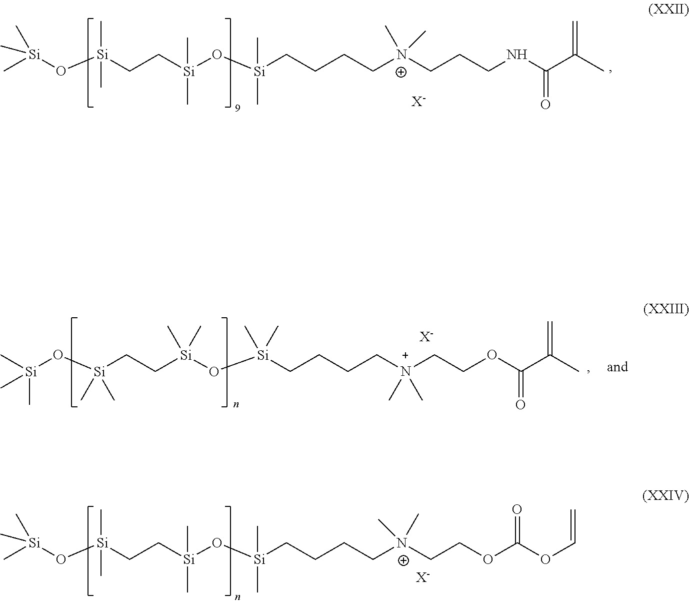

wherein n is as defined above and X⁻ is a counterion to provide an overall neutral charge.

Counterions capable of providing an overall neutral charge are well known to those of ordinary skill in the art and would include, for example, halide ions.

In an illustrative embodiment, as may be combined with one or more of the preceding paragraphs, the one or more ophthalmic device-forming silicone comonomers can include, as a class of representative ophthalmic device-forming silicone comonomers, one or more monomers of Formula XXV:

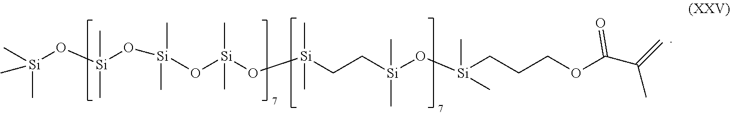

Another class of representative ophthalmic device-forming silicone comonomers includes, for example, fluorinated monomers. Such monomers have been used in the formation of fluorosilicone hydrogels to reduce the accumulation of deposits on contact lenses made therefrom, as disclosed in, for example, U.S. Pat. Nos. 4,954,587; 5,010,141 and 5,079,319. Also, the use of silicone-containing monomers having certain fluorinated side groups, i.e., —(CF₂)—H, have been found to improve compatibility between the hydrophilic and silicone-containing monomeric units. See, e.g., U.S. Pat. Nos. 5,321,108 and 5,387,662.

The above silicone materials are merely exemplary, and other materials for use as substrates that have been disclosed in various publications and are being continuously developed for use in contact lenses and other ophthalmic devices can also be used. For example, an ophthalmic device can be formed from at least a cationic monomer such as cationic silicone-containing monomers or cationic fluorinated silicone-containing monomers.

In accordance with one or more additional non-limiting illustrative embodiments, as may be combined with one or more of the preceding paragraphs, the one or more ophthalmic device-forming silicone comonomers can be present in the monomeric mixture in an amount ranging from about 5 wt. % to about 50 wt. %, based on the total weight of the monomeric mixture. In another illustrative embodiment, the one or more ophthalmic device-forming silicone comonomers can be present in the monomeric mixture in an amount ranging from about 10 wt. % to about 30 wt. %, based on the total weight of the monomeric mixture.

In non-limiting illustrative embodiments, as may be combined with one or more of the preceding paragraphs, the monomeric mixture can further contain one or more crosslinking agents. Suitable crosslinking agents for use herein are known in the art. For example, in non-limiting illustrative embodiments, suitable one or more cross-linking agents include one or more crosslinking agents containing at least two ethylenically unsaturated reactive end groups. In one embodiment, the ethylenically unsaturated reactive end groups are (meth)acrylate-containing reactive end groups. In another embodiment, the ethylenically unsaturated reactive end groups are non-(meth)acrylate reactive end groups. In one embodiment, the ethylenically unsaturated reactive end groups are a combination of one or more (meth)acrylate-containing reactive end groups and one or more non-(meth)acrylate reactive end groups.

In an illustrative embodiment, useful one or more crosslinking agents containing at least two ethylenically unsaturated reactive end groups include, for example, one or more di, tri- or tetra(meth)acrylate-containing crosslinking agents. In an illustrative embodiment, useful one or more di-, tri- or tetra(meth)acrylate-containing crosslinking agents include, for example, alkanepolyol di-, tri- or tetra(meth)acrylate-containing crosslinking agents such as, for example, one or more alkylene glycol di(meth)acrylate crosslinking agents, one or more alkylene glycol tri(meth)acrylate crosslinking agents, one or more alkylene glycol tetra(meth)acrylate crosslinking agents, one or more alkanediol di(meth)acrylate crosslinking agents, alkanediol tri(meth)acrylate crosslinking agents, alkanediol tetra(meth)acrylate crosslinking agents, agents, one or more alkanetriol di(meth)acrylate crosslinking agents, alkanetriol tri(meth)acrylate crosslinking agents, alkanetriol tetra(meth)acrylate crosslinking agents, agents, one or more alkanetetraol di(meth)acrylate crosslinking agents, alkanetetraol tri(meth)acrylate crosslinking agents, alkanetetraol tetra(meth)acrylate crosslinking agents and the like and mixtures thereof.

In an illustrative embodiment, one or more alkylene glycol di(meth)acrylate crosslinking agents include tetraethylene glycol dimethacrylate, ethylene glycol di(meth)acrylates having up to about 10 ethylene glycol repeating units, butyleneglycol di(meth)acrylate and the like. In one embodiment, one or more alkanediol di(meth)acrylate crosslinking agents include butanediol di(meth)acrylate crosslinking agents, hexanediol di(meth)acrylate and the like. In one embodiment, one or more alkanetriol tri(meth)acrylate crosslinking agents are trimethylol propane trimethacrylate crosslinking agents. In one embodiment, one or more alkanetetraol tetra(meth)acrylate crosslinking agents are pentaerythritol tetramethacrylate crosslinking agents.

In a non-limiting illustrative embodiment, suitable crosslinking agents include, for example, ethylene glycol diacrylate, diethylene glycol diacrylate, allyl acrylate, 1,3-propanediol diacrylate, 2,3-propanediol diacrylate, 1,6-hexanediol diacrylate, 1,4-butanediol diacrylate, triethylene glycol diacrylate, cyclohexane-1,1-diyldimethanol diacrylate, 1,4-cyclohexanediol diacrylate, 1,3-adamantanediol diacrylate, 1,3-adamantanedimethyl diacrylate, 2,2-diethyl-1,3-propanediol diacrylate, 2,2-diisobutyl-1,3-propanediol diacrylate, 1,3-cyclohexanedimethyl diacrylate, 1,4-cyclohexanedimethyl diacrylate; neopentyl glycol diacrylate, tetraethyleneglycol diacrylate, polyethyleneglycol diacrylate; and their corresponding methacrylates.

In a non-limiting illustrative embodiment, suitable crosslinking agents include, for example, 1,4-butanediol diacrylate, 1,4-butanediol dimethacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, 1,3-propanediol diacrylate, 1,3-propanediol dimethacrylate, 1,6-hexanediol diacrylate, 1,6-hexanediol dimethacrylate, poly(ethylene glycol) diacrylate (Mn=700 Daltons), poly(ethylene glycol) dimethacrylate (Mn=700 Daltons), and poly(ethylene glycol) dimethacrylate (Mn=1000 Daltons).

In one embodiment, the one or more crosslinking agents containing at least two ethylenically unsaturated reactive end groups include at least one allyl-containing reactive end group and at least one (meth)acrylate-containing reactive end group. In an illustrative embodiment, the one or more crosslinking agents can be allyl methacrylate.

In non-limiting illustrative embodiments, as may be combined with one or more of the preceding paragraphs, the one or more crosslinking agents can be present in the monomeric mixture in an ophthalmic device-forming amount. In non-limiting illustrative embodiments, as may be combined with one or more of the preceding paragraphs, the one or more crosslinking agents are present in the monomeric mixture in an amount of about 0.1 to about 3.0 wt. %, based on the total weight of the monomeric mixture. In non-limiting illustrative embodiments, as may be combined with one or more of the preceding paragraphs, the one or more crosslinking agents are present in the monomeric mixture in an amount of about 0.2 to about 1.0 wt. %, based on the total weight of the monomeric mixture.

In accordance with one or more additional non-limiting illustrative embodiments, as may be combined with one or more of the preceding paragraphs, the monomeric mixture can further contain one or more additional ophthalmic device-forming comonomers. In an illustrative embodiment, the one or more additional ophthalmic device-forming comonomers can include, for example, both an ethylenically unsaturated group (that permits the monomer to copolymerize with the ophthalmic device-forming hydrophilic comonomer) and an epoxide group (that does not react with the ophthalmic device-forming hydrophilic comonomer but remains to react with the copolymer). Suitable additional ophthalmic device-forming comonomers include, for example, glycidyl methacrylate, glycidyl acrylate, glycidyl vinylcarbonate, glycidyl vinylcarbamate, 4-vinyl-1-cyclohexene-1,2-epoxide and the like.

In non-limiting illustrative embodiments, the one or more additional ophthalmic device-forming comonomers can be present in the monomeric mixture in an amount ranging from about 1 wt. % to about 20 wt. %, based on the total weight of the monomeric mixture. In another illustrative embodiment, the one or more additional ophthalmic device-forming comonomers can be present in the monomeric mixture in an amount ranging from about 3 wt. % to about 10 wt. %, based on the total weight of the monomeric mixture.

In non-limiting illustrative embodiments, as may be combined with one or more of the preceding paragraphs, the monomeric mixture can further contain a reactive (polymerizable) ultraviolet (UV) light absorber and/or a reactive blue-light absorber. Suitable reactive UV light absorbers can be any known reactive UV absorber. In non-limiting illustrative embodiments, suitable reactive UV light absorbers include, for example, 2-(2′-hydroxy-3′-methallyl-5′-methylphenyl)benzotriazole, commercially available as o-Methallyl Tinuvin P (“oMTP”) from Polysciences, Inc., Warrington, Pa., 3-(2H-benzo[d][1,2,3]triazol-2-yl)-4-hydroxyphenylethyl methacrylate, and 2-(3-(tert-butyl)-4-hydroxy-5-(5-methoxy-2H-benzo[d][1,2,3]triazol-2-yl)phenoxy)ethyl methacrylate.

In one illustrative embodiment, suitable UV light absorbers include, for example, on

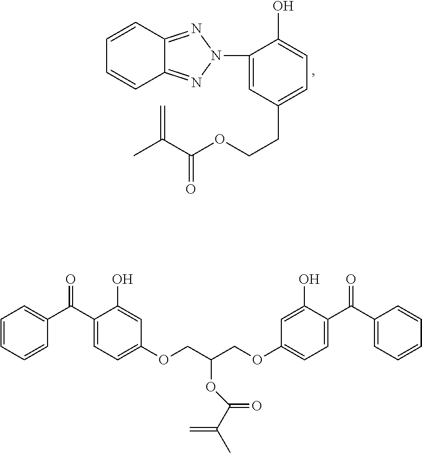 [SMILES: C=C(C)C(=O)OCCc1ccc(O)c(-n2nc3ccccc3n2)c1 ; C=C(C)C(=O)OC(COc1ccc(C(=O)c2ccccc2)c(O)c1)COc1ccc(C(=O)c2ccccc2)c(O)c1]

### (2-Propenoic acid, 2-methyl,2-(4-benzoyl-3-hydroxyphenoxy)-1-[(4-benzoyl3-hydroxyphenoxy)methyl ester)

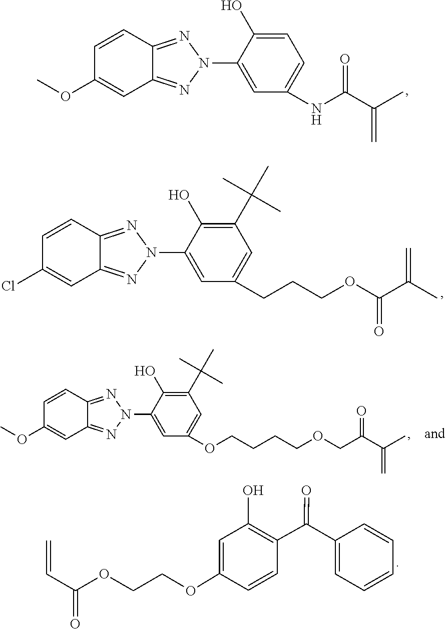

These compounds are merely illustrative and not intended to be limiting. Any known UV blocker or later developed UV blocker are contemplated for use herein.

In illustrative embodiments, the UV light absorbers can be present in the monomeric mixture in an amount ranging from about 0.1 to about 5 wt. %, based on the total weight of the monomeric mixture. In another illustrative embodiment, the UV light absorbers can be present in the monomeric mixture in an amount ranging from about 1.5 to about 2.5 wt. %, based on the total weight of the monomeric mixture. In yet another non-limiting illustrative embodiment, the UV light absorbers can be present in the monomeric mixture in an amount ranging from about 1.5 to about 2 wt. %, based on the total weight of the monomeric mixture.

Many reactive blue-light absorbing compounds are known. Preferred reactive blue-light absorbing compounds are those described in U.S. Pat. Nos. 5,470,932; 8,207,244; and 8,329,775, the contents of which are hereby incorporated by reference. In one embodiment, a blue-light absorbing dye is N-2-[3-(2′-methylphenylazo)-4-hydroxyphenyl]ethyl methacrylamide. In illustrative embodiments, the blue-light absorbers can be present in the monomeric mixture in an amount ranging from about 0.005 to about 1 wt. %, based on the total weight of the monomeric mixture. In another illustrative embodiment, the blue-light absorbers can be present in the monomeric mixture in an amount ranging from about 0.01 to about 1 wt. %, based on the total weight of the monomeric mixture.

In non-limiting illustrative embodiments, as may be combined with one or more of the preceding paragraphs, the monomeric mixture can further contain a diluent. Suitable diluents include, for example, at least one or more boric acid esters of a C₁ to C₈ monohydric alcohol, water-soluble or partly water-soluble monohydric alcohols and mixtures thereof. In one embodiment, a diluent includes, for example, at least one or more boric acid esters of a C₁ to C₅ monohydric alcohol. Suitable boric acid esters of a C₁ to C₈ monohydric alcohol include, for example, trimethyl borate, triethyl borate, tri-n-propyl borate, triisopropyl borate, tri-n-butyl borate, and tri-tert-butyl borate. Suitable water-soluble or partly water-soluble monohydric alcohols include, for example, monohydric alcohols having from 1 to 5 carbon atoms such as methanol, ethanol, isopropyl alcohol, 1-propanol, t-butyl alcohol, 2-butyl alcohol, 2-methyl-1-propanol, t-amyl alcohol and other C₅ isomers.

In non-limiting illustrative embodiments, as may be combined with one or more of the preceding paragraphs, the monomeric mixture contains about 5 wt. % to about 50 wt. % of the diluent, based on the total weight of the monomeric mixture. In one embodiment, the monomeric mixture contains about 15 wt. % to about 30 wt. % of the diluent, based on the total weight of the monomeric mixture.

The monomeric mixture may further contain, as necessary and within limits not to impair the purpose and effect of the illustrative embodiments, various additives such as an antioxidant, coloring agent, lubricant, internal wetting agent, toughening agent and the like and other constituents as are well known in the art.

In non-limiting illustrative embodiments, as may be combined with one or more of the preceding paragraphs, the ophthalmic devices disclosed herein can be a high-water content silicone ophthalmic device such as silicone hydrogel having an equilibrium water content of at least about 35 wt. %. In another illustrative embodiment, the high-water content silicone ophthalmic device disclosed herein can have an equilibrium water content of at least about 50 wt. %. In another illustrative embodiment, the high-water content silicone ophthalmic device disclosed herein can have an equilibrium water content of at least about 60 wt. %. In another illustrative embodiment, the high-water content silicone ophthalmic device disclosed herein can have an equilibrium water content of at least about 70 wt. %. In another illustrative embodiment, the ophthalmic devices disclosed herein can be a high-water content silicone ophthalmic device having an equilibrium water content of from about 35 wt. % to about 80 wt.

The ophthalmic devices of the illustrative embodiments, e.g., contact lenses or intraocular lenses, can be prepared by polymerizing the foregoing monomeric mixtures to form a product that can be subsequently formed into the appropriate shape by, for example, lathing, injection molding, compression molding, cutting and the like. For example, in producing contact lenses, the initial mixture may be polymerized in tubes to provide rod-shaped articles, which are then cut into buttons. The buttons may then be lathed into contact lenses.

Alternately, the ophthalmic devices such as contact lenses may be cast directly in molds, e.g., polypropylene molds, from the mixtures, e.g., by spincasting and static casting methods. Spincasting methods are disclosed in U.S. Pat. Nos. 3,408,429 and 3,660,545, and static casting methods are disclosed in U.S. Pat. Nos. 4,113,224, 4,197,266, and 5,271,875. Spincasting methods involve charging the mixtures to be polymerized to a mold, and spinning the mold in a controlled manner while exposing the mixture to a radiation source such as UV light. Static casting methods involve charging the monomeric mixture between two mold sections, one mold section shaped to form the anterior lens surface and the other mold section shaped to form the posterior lens surface, and curing the mixture while retained in the mold assembly to form a lens, for example, by free radical polymerization of the mixture. Examples of free radical reaction techniques to cure the lens material include thermal radiation, infrared radiation, electron beam radiation, gamma radiation, ultraviolet (UV) radiation, and the like; or combinations of such techniques may be used. U.S. Pat. No. 5,271,875 describes a static cast molding method that permits molding of a finished lens in a mold cavity defined by a posterior mold and an anterior mold. As an additional method, U.S. Pat. No. 4,555,732 discloses a process where an excess of a monomeric mixture is cured by spincasting in a mold to form a shaped article having an anterior lens surface and a relatively large thickness, and the posterior surface of the cured spincast article is subsequently lathed to provide a contact lens having the desired thickness and posterior lens surface.

Polymerization may be facilitated by exposing the mixture to heat (thermal cure) and/or radiation, such as ultraviolet light, visible light, or high energy radiation. A polymerization initiator may be included in the mixture to facilitate the polymerization step. Representative examples of free radical thermal polymerization initiators include organic peroxides such as acetyl peroxide, lauroyl peroxide, decanoyl peroxide, stearoyl peroxide, benzoyl peroxide, tertiarylbutyl peroxypivalate, peroxydicarbonate, and the like. Representative examples of diazo initiators include VAZO 64, and VAZO 67. Representative UV initiators are those known in the art and include benzoin methyl ether, benzoin ethyl ether, Darocure® 1173, 1164, 2273, 1116, 2959, 3331 (EM Industries) and Irgacure® 651 and 184 (Ciba-Geigy). Representative visible light initiators include IRGACURE 819 and other phosphine oxide-type initiators, and the like. Generally, the initiator will be employed in the monomeric mixture at a concentration of about 0.01 to about 5 wt. % of the total mixture.

Polymerization is generally performed in a reaction medium, such as, for example, a solution or dispersion using a solvent, e.g., water or an alkanol containing from 1 to 4 carbon atoms such as methanol, ethanol or propan-2-ol. Alternatively, a mixture of any of the above solvents may be used.

Generally, polymerization can be carried out for about 15 minutes to about 72 hours, and under an inert atmosphere of, for example, nitrogen or argon. If desired, the resulting polymerization product can be dried under vacuum, e.g., for about 5 to about 72 hours, or left in an aqueous solution prior to use.

Polymerization of the mixtures will yield a polymer, that when hydrated, preferably forms a hydrogel. When producing a hydrogel lens, the mixture may further include at least a diluent as discussed above that is ultimately replaced with water when the polymerization product is hydrated to form a hydrogel. Generally, the water content of the hydrogel is as described hereinabove, i.e., at least about 50 wt. %. The amount of diluent used should be less than about 50 wt. % and in most cases, the diluent content will be less than about 30 wt. %. However, in a particular polymer system, the actual limit will be dictated by the solubility of the various monomers in the diluent. In order to produce an optically clear copolymer, it is important that a phase separation leading to visual opacity does not occur between the comonomers and the diluent, or the diluent and the final copolymer.

Furthermore, the maximum amount of diluent which may be used will depend on the amount of swelling the diluent causes the final polymers. Excessive swelling will or may cause the copolymer to collapse when the diluent is replaced with water upon hydration. Suitable diluents include, but are not limited to, ethylene glycol; glycerine; liquid poly(ethylene glycol); alcohols; alcohol/water mixtures; ethylene oxide/propylene oxide block copolymers; low molecular weight linear poly(2-hydroxyethyl methacrylate); glycol esters of lactic acid; formamides; ketones; dialkylsulfoxides; butyl carbitol; borates as discussed herein and the like and mixtures thereof.

If necessary, it may be desirable to remove residual diluent from the lens before edge-finishing operations which can be accomplished by evaporation at or near ambient pressure or under vacuum. An elevated temperature can be employed to shorten the time necessary to evaporate the diluent. The time, temperature and pressure conditions for the solvent removal step will vary depending on such factors as the volatility of the diluent and the specific monomeric components, as can be readily determined by one skilled in the art. If desired, the mixture used to produce the hydrogel lens may further include wetting agents known in the prior art for making hydrogel materials.

In the case of intraocular lenses, the monomeric mixtures to be polymerized may further include a monomer for increasing the refractive index of the resultant polymerized product. Examples of such monomers include aromatic (meth) acrylates, such as phenyl (meth)acrylate, 2-phenylethyl (meth)acrylate, 2-phenoxyethyl methacrylate, and benzyl (meth)acrylate.

The ophthalmic devices such as contact lenses obtained herein may be subjected to optional machining operations. For example, the optional machining steps may include buffing or polishing a lens edge and/or surface. Generally, such machining processes may be performed before or after the product is released from a mold part, e.g., the lens is dry released from the mold by employing vacuum tweezers to lift the lens from the mold, after which the lens is transferred by means of mechanical tweezers to a second set of vacuum tweezers and placed against a rotating surface to smooth the surface or edges. The lens may then be turned over in order to machine the other side of the lens.

The lens may then be transferred to individual lens packages containing a buffered saline solution. The saline solution may be added to the package either before or after transfer of the lens. Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, autoclaving.

As one skilled in the art will readily appreciate other steps may be included in the molding and packaging process described above. Such other steps can include, for example, coating the formed lens, surface treating the lens during formation (e.g., via mold transfer), inspecting the lens, discarding defective lenses, cleaning the mold halves, reusing the mold halves, and the like and combinations thereof.

The following examples are provided to enable one skilled in the art to practice the invention and are merely illustrative. The examples should not be read as limiting the scope of the invention as defined in the claims.

In the examples, the following abbreviations are used.

HEMA: 2-hydroxyethyl methacrylate.

NVP: N-vinyl-2-pyrrolidone.

DMA: N,N-dimethylacrylamide.

EGDMA: Ethylene glycol dimethacrylate.

AMA: Allyl methacrylate.

TRIS: Tris(trimethylsiloxy)silylpropyl methacrylate.

TRIS MA: Tris (trimethoxysilylpropyl)methacrylate.

SIGMA: (3-methacryloxy-2-hydroxypropoxy)propylbis(trimethylsiloxy) methyl silane.

PVP: Polyvinylpyrrolidone having a weight average molecular weight of 1,300,000 Da.

Capmul PG-8: Propylene glycol monocaprylate.

UV416: 2-(4-Benzoyl-3-hydroxyphenoxy)ethyl acrylate.

Vazo™ 64: azo bis-isobutylnitrile (AIBN).

IMVT: 1,4-bis(4-(2-methacryloxyethyl)phenylamino)anthraquinone.

M1EDS6: A compound having the following structure and available from Gelest:

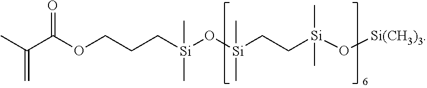

MCR-M11: A compound having the structure:

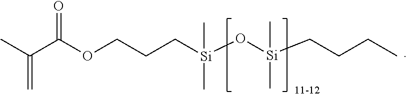

SA monomer: A compound having the structure:

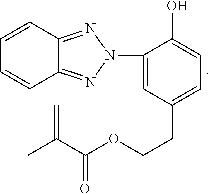 [SMILES: C=C(C)C(=O)OCCc1ccc(O)c(-n2nc3ccccc3n2)c1]

Poloxamer 407DM: Pluronic 407 dimethacrylate having the following structure:

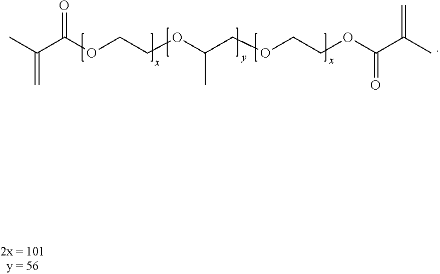

X-22-1666C: A compound available from ShinEtsu and having the following structure:

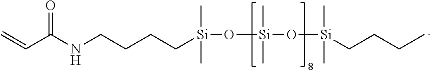

X-22-1602P: A compound available from ShinEtsu and having the following structure:

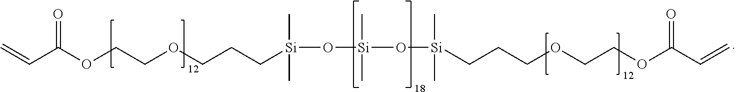

SKD-131-069-92: A compound available from Momentive and having the following structure:

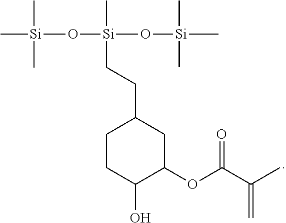 [SMILES: C=C(C)C(=O)OC1CC(CC[Si](C)(O[Si](C)(C)C)O[Si](C)(C)C)CCC1O]

Various polymerization products were formed as discussed below and characterized by standard testing procedures such as:

Oxygen permeability (also referred to as Dk) is determined by the following procedure. Other methods and/or instruments may be used as long as the oxygen permeability values obtained therefrom are equivalent to the described method. The oxygen permeability of silicone hydrogels is measured by the polarographic method (ANSI Z80.20-1998) using an 02 Permeometer Model 201T instrument (Createch, Albany, Calif. USA) having a probe comprising a central, circular gold cathode at its end and a silver anode insulated from the cathode. Measurements are taken only on pre-inspected pinhole-free, flat silicone hydrogel film samples of three different center thicknesses ranging from 150 to 600 microns. Center thickness measurements of the film samples may be measured using a Rehder ET-1 electronic thickness gauge. Generally, the film samples have the shape of a circular disk. Measurements are taken with the film sample and probe immersed in a bath comprising circulating phosphate buffered saline (PBS) equilibrated at 35° C.+/−0.2°. Prior to immersing the probe and film sample in the PBS bath, the film sample is placed and centered on the cathode premoistened with the equilibrated PBS, ensuring no air bubbles or excess PBS exists between the cathode and the film sample, and the film sample is then secured to the probe with a mounting cap, with the cathode portion of the probe contacting only the film sample. For silicone hydrogel films, it is frequently useful to employ a Teflon polymer membrane, e.g., having a circular disk shape, between the probe cathode and the film sample. In such cases, the Teflon membrane is first placed on the pre-moistened cathode, and then the film sample is placed on the Teflon membrane, ensuring no air bubbles or excess PBS exists beneath the Teflon membrane or film sample. Once measurements are collected, only data with a correlation coefficient value (R²) of 0.97 or higher should be entered into the calculation of Dk value. At least two Dk measurements per thickness, and meeting R2 value, are obtained.

Using known regression analyses, oxygen permeability (Dk) is calculated from the film samples having at least three different thicknesses. Any film samples hydrated with solutions other than PBS are first soaked in purified water and allowed to equilibrate for at least 24 hours, and then soaked in PHB and allowed to equilibrate for at least 12 hours. The instruments are regularly cleaned and regularly calibrated using RGP standards. Upper and lower limits are established by calculating a +/−8.8% of the Repository values established by William J. Benjamin, et al., The Oxygen Permeability of Reference Materials, Optom Vis Sci 7 (12s): 95 (1997), the disclosure of which is incorporated herein in its entirety.

Water %: Two sets of six hydrated lenses or films are blotted dry on a piece of filter paper to remove excess water, and samples are weighed (wet weight). Samples are then placed in a microwave oven for 10 minutes inside a jar containing desiccant. The samples are then allowed to sit for 30 minutes to equilibrate to room temperature and reweighed (dry weight). The percent water is calculated from the wet and dry weights.

Contact Angle (CBCA): Captive bubble contact angle data was collected on a First Ten Angstroms FTA-1000 prop Shape Instrument. All samples were rinsed in HPLC grade water prior to analysis in order to remove components of the packaging solution from the sample surface. Prior to data collection the surface tension of the water used for all experiments was measured using the pendant drop method. In order for the water to qualify as appropriate for use, a surface tension value of 70-72 dynes/cm was expected. All lens samples were placed onto a curved sample holder and submerged into a quartz cell filled with HPLC grade water. Advancing and receding captive bubble contact angles were collected for each sample. The advancing contact angle is defined as the angle measured in water as the air bubble is retracting from the lens surface (water is advancing across the surface). All captive bubble data was collected using a high-speed digital camera focused onto the sample/air bubble interface. The contact angle was calculated at the digital frame just prior to contact line movement across the sample/air bubble interface. The receding contact angle is defined as the angle measured in water as the air bubble is expanding across the sample surface (water is receding from the surface).

Modulus (g/mm²) and % elongation were measured per ASTM 1708 employing an Instron (Model 4502) instrument where the film sample was immersed in borate buffered saline; an appropriate size of the film sample was gauge length 22 mm and width 4.75 mm, where the sample further has ends forming a dog-bone shape to accommodate gripping of the sample with clamps of the Instron instrument, and a thickness of 100±50 microns.

Tensile strength (g/mm²) was measured per ASTM test method D1708a.

Clarity/Cloudy—clarity/cloudy is measured by placing a lens in a wet cell and assessing the clearest and cloudiest portions of the lens compared to a set of standards. Ratings are assigned a value of 1 to 5 with a rating of 5 indicating the lens is clear and a rating of 1 indicating the lens is cloudy.

### Example 1

Preparation of a silicone monomer having the following structure:

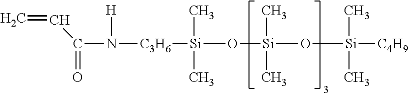

by the general reaction scheme.

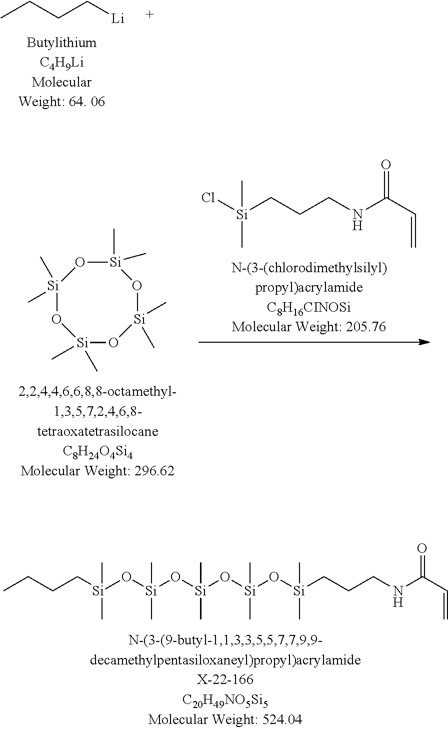

To an oven dried 2 L two-neck round bottom flask equipped with a magnetic stirring bar and condenser under N₂ atmosphere were added 2,2,4,4,6,6,8,8-octamethyl-1,3,5,7,2,4,6,8-tetraoxatetrasilocane (29.6 g g, 0.1 mol) and anhydrous cyclohexane (150 mL) under stirring in N₂ atmosphere. Butyllithium (6.4 g, 0.1 mol) was added to the above reaction mixture followed by the addition of cyclohexane (25 mL). After stirring for one hour, tertrahydrofuran (THF) (70 mL, distilled over sodium/benzophenone) was added and the reaction mixture continued to stir for 16 hours. Next, N-(3-(chlorodimethylsilyl)propyl)acrylamide (20.5 g, 0.1 mol) was added and the mixture was stirred for another 24 hours. The reaction mixture was then filtered and Silica gel (3.5 g, dried at 160° C. for 3 h) was added and the reaction mixture was stirred for an additional 4 hours. The reaction mixture was filtered through a bed of Celite (20 g) and butylated hydroxytoluene (BHT) (5 mg) was added to the filtrate. The filtrate was then concentrated under vacuum (40° C./0.3 mm Hg). Heptane (200 mL) was added to the concentrate with stirring and washed with DI water (100 mL), aqueous NaHCO₃ (2×100 mL, prepared by dissolving 10 g NaHCO₃ in 200 mL DI water), brine (100 mL) and finally DI water (100 mL). Heptane (50 mL) was added and dried over MgSO₄ (15 g) for 20 hours. The MgSO₄ was filtered off and the solvent was removed on rotary evaporator. The crude product was stirred over activated basic Alumina (30 g for 24 h) and then filtered over a thin bed of celite. Stripping off any residue solvent at 25° C.; at 0.2 mmHg for 30 minutes yielded the desired product as clear oil in 40 g quantity.

### Example 2 and Comparative Examples A and B

A monomer mix was made by mixing the following components, listed in Table 1 at amounts per weight.

TABLE 1

| | | Comp. | Comp. |
|---|---|---|---|
| Formulation | Ex. 2 | Ex. A | Ex. B |
| NVP | 49.74 | 49.74 | 49.74 |
| Glycidyl MA | 4.98 | 4.98 | 4.98 |
| EGDMA | 0.88 | 0.88 | 0.88 |
| Silicone Monomer | 17.64 | — | — |
| of Example 1 | | | |
| MCR-M11 | — | 17.64 | — |
| M1EDS6 | — | — | 17.64 |
| TRIS | 9.83 | 9.83 | 9.83 |
| DMA | 4.92 | 4.92 | 4.92 |
| Propylene Glycol | 9.83 | 9.83 | 9.83 |
| Vazo 64 | 0.20 | 0.20 | 0.20 |
| UV-416 | 1.97 | 1.97 | 1.97 |
| Tint | 0.02 | 0.02 | 0.02 |
| Properties | | | |
| Water content, % | 61.32 | — | — |
| CBCA | 43 | — | — |
| Clarity/Cloudy | 5/4 | — | — |
| Dk | 55.5 | — | — |
| Dk/t @ 70 mm | 79.3 | — | — |

The resultant monomeric mixture was cast into contact lenses by introducing the monomeric mixture to a polypropylene mold assembly. Then, the mold assembly and monomeric mixture were thermally cured for about 3 hours to form a contact lens. The resultant contact lenses were released from the mold assembly.

The monomeric mixture of Example 2 was uniform resulting in a contact lens with optical clarity. The monomeric mixtures of Comparative Examples A and B separated during polymerization resulting in non-uniform lenses.

### Example 3 and Comparative Examples C and D

A monomer mix was made by mixing the following components, listed in Table 2 at amounts per weight.

TABLE 2

| | | Comp. | Comp. |
|---|---|---|---|
| Formulation | Ex. 3 | Ex. C | Ex. D |
| SIGMA | 22.16 | 22.16 | 22.16 |
| PVP | 8.67 | 8.67 | 8.67 |
| DMA | 18.88 | 18.88 | 18.88 |
| Silicone Monomer | 24.37 | — | — |
| of Example 1 | | | |
| MCR-M11 | — | 24.37 | — |
| M1EDS6 | — | — | 24.37 |
| HEMA | 5.78 | 5.78 | 5.78 |
| EGDMA | 0.96 | 0.96 | 0.96 |
| Capmul PG-8 | 18.79 | 18.79 | 18.79 |
| Vazo 64 | 0.39 | 0.39 | 0.39 |
| Properties | | | |
| Water content, % | 38.53 | — | — |
| Modulus | 79 | — | — |
| CBCA | 38 | — | — |
| Clarity/Cloudy | 4/4 | — | — |
| Dk (4 thickness) | 106.3 | — | — |

The resultant monomeric mixture was cast into contact lenses by introducing the monomeric mixture to a polypropylene mold assembly. Then, the mold assembly and monomeric mixture were thermally cured for about 3 hours to form a contact lens. The resultant contact lenses were released from the mold assembly.

The monomeric mixture of Example 3 was uniform resulting in a contact lens with optical clarity. The monomeric mixtures of Comparative Examples C and D were phase separated during polymerization resulting in phase separated lenses with no clarity.

### Example 4 and Comparative Example E

A monomer mix was made by mixing the following components, listed in Table 3 at amounts per weight.

TABLE 3

| | | Comp. |
|---|---|---|
| Formulation | Ex. 4 | Ex. E |
| NVP | 53.069 | 53.069 |
| Methoxyethyl | 5.328 | 5.325 |
| Methacrylate | | |
| EGDMA | 0.426 | 0.426 |
| Silicone Monomer | 18.755 | — |
| of Example 1 | | |
| X-22-1666C | — | 18.755 |
| TrisMA | 10.443 | 10.433 |
| DMA | 5.264 | 5.264 |
| Poloxamer | 5.328 | 5.328 |
| 407DM | | |
| AMA | 0.107 | 0.107 |
| Vazo 64 | 0.213 | 0.213 |
| SA Monomer | 1.066 | 1.066 |
| IMVT | 0.020 | 0.020 |
| Properties | | |
| Water content, % | 68 | — |
| Modulus | 40 | — |
| CBCA | 55 | — |
| Dk | 60 | — |
| UV blocking | Class I | — |

The resultant monomeric mixture was cast into contact lenses by introducing the monomeric mixture to a polypropylene mold assembly. Then, the mold assembly and monomeric mixture were thermally cured for about 3 hours to form a contact lens. The resultant contact lenses were released from the mold assembly.

The monomeric mixture of Example 4 was uniform resulting in a contact lens with optical clarity. The monomeric mixture of Comparative Example E was non-uniform during polymerization resulting in a cloudy mixture with no clarity.

### Example 5 and Comparative Example F

A monomer mix was made by mixing the following components, listed in Table 4 at amounts per weight.

TABLE 4

| | | Comp. |
|---|---|---|
| Formulation | Ex. 5 | Ex. F |
| NVP | 60 | 60 |
| HEMA | 15 | 15 |
| DMA | 10 | 10 |
| Silicone Monomer | 10 | — |
| of Example 1 | | |
| X-22-1666C | — | 10 |
| AMA | 0.15 | 0.15 |
| X-22-1602P | 3 | 3 |
| Poloxamer | 1 | 1 |
| 407DM | | |
| SKD-131-069-92 | 5 | 5 |
| Propylene Glycol | 15 | 15 |
| AIBN | 0.5 | 0.5 |
| IMVT | 0.01 | 0.01 |
| Properties | | |
| Water content, % | 72.94 | — |
| CBCA | 64 | — |
| Modulus | 44 | — |
| Tensile Strength | 69 | — |
| Elongation, % | 224 | — |
| Toughness | 76 | — |

The resultant monomeric mixture was cast into contact lenses by introducing the monomeric mixture to a polypropylene mold assembly. Then, the mold assembly and monomeric mixture were thermally cured for about 3 hours to form a contact lens. The resultant contact lenses were released from the mold assembly.

The monomeric mixture of Example 5 was uniform resulting in a contact lens with optical clarity. The monomeric mixture of Comparative Example F was non-uniform during polymerization resulting in a cloudy mixture with no clarity.

According to an aspect of the disclosure, a monofunctional silicone monomer is represented by a structure of Formula I:

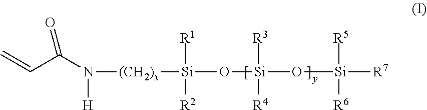

wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 5.

In non-limiting illustrative embodiments, as may be combined with one or more of the preceding paragraphs, R¹, R², R³ and R⁴ are independently hydrogen, a C₁ to Cu alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 5.

In non-limiting illustrative embodiments, as may be combined with one or more of the preceding paragraphs, R¹, R², R³ and R⁴ are independently hydrogen, a C₁ to C₆ alkyl group; R⁵, R⁶ and R⁷ are independently a straight or branched C₁ to C₆ alkyl group; x is from 1 to 6; and y is from 3 to 5.

In non-limiting illustrative embodiments, as may be combined with one or more of the preceding paragraphs, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 5.

In non-limiting illustrative embodiments, as may be combined with one or more of the preceding paragraphs, R¹, R², R³, R⁴, R⁵ and R⁶ are methyl; R⁷ is a straight or branched C₃ to C₆ alkyl group; x is from 2 to 4; and y is from 3 to 5.

According to another aspect of the disclosure, an ophthalmic device is a polymerization product of a monomeric mixture comprising:
(a) one or more monofunctional silicone monomers represented by a structure of Formula I:

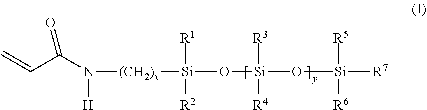

wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 5, and
(b) one or more ophthalmic device-forming hydrophilic comonomers.

In non-limiting illustrative embodiments, as may be combined with one or more of the preceding paragraphs, where in the monofunctional silicone monomer, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 5.

In non-limiting illustrative embodiments, as may be combined with one or more of the preceding paragraphs, where in the monofunctional silicone monomer, R¹, R², R³ and R⁴ are independently hydrogen, a C₁ to C₆ alkyl group; R⁵, R⁶ and R⁷ are independently a straight or branched C₁ to C₆ alkyl group; x is from 1 to 6; and y is from 3 to 5.

In non-limiting illustrative embodiments, as may be combined with one or more of the preceding paragraphs, where in the monofunctional silicone monomer, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 5.

In non-limiting illustrative embodiments, as may be combined with one or more of the preceding paragraphs, where in the monofunctional silicone monomer, R¹, R², R³, R⁴, R⁵ and R⁶ are methyl; R⁷ is a straight or branched C₃ to C₆ alkyl group; x is from 2 to 4; and y is from 3 to 5.

In non-limiting illustrative embodiments, as may be combined with one or more of the preceding paragraphs, the one or more ophthalmic device-forming hydrophilic comonomers are selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

In non-limiting illustrative embodiments, as may be combined with one or more of the preceding paragraphs, the one or more ophthalmic device-forming hydrophilic comonomers are selected from the group consisting of an acrylamide, a vinyl lactam and a hydroxyl-containing-(meth)acrylate.

In non-limiting illustrative embodiments, as may be combined with one or more of the preceding paragraphs, the acrylamide is one or more of N,N-dimethylacrylamide and N,N-dimethylmethacrylamide.

In non-limiting illustrative embodiments, as may be combined with one or more of the preceding paragraphs, the cyclic lactam is one or more of N-vinyl-2-pyrrolidone, N-vinyl caprolactam and N-vinyl-2-piperidone.

In non-limiting illustrative embodiments, as may be combined with one or more of the preceding paragraphs, the hydroxyl-containing (meth)acrylate is one or more of 2-hydroxyethyl methacrylate (HEMA) and glycerol methacrylate.

In non-limiting illustrative embodiments, as may be combined with one or more of the preceding paragraphs, wherein the monomeric mixture comprises:

about 1 wt. % to about 40 wt. %, based on the total weight of the monomeric mixture, of the one or more monofunctional silicone monomers, and

about 10 wt. % to 80 wt. %, based on the total weight of the monomeric mixture, of the one or more ophthalmic device-forming hydrophilic comonomers.

In non-limiting illustrative embodiments, as may be combined with one or more of the preceding paragraphs, the monomeric mixture further comprises one or more non-functionalized comfort polymers.

In non-limiting illustrative embodiments, as may be combined with one or more of the preceding paragraphs, the one or more non-functionalized comfort polymers comprise a polyvinylpyrrolidone polymer.

In non-limiting illustrative embodiments, as may be combined with one or more of the preceding paragraphs, the polyvinylpyrrolidone polymer has a weight average molecular weight of at least about 10,000.

In non-limiting illustrative embodiments, as may be combined with one or more of the preceding paragraphs, the polyvinylpyrrolidone polymer has a weight average molecular weight of from about 10,000 to about 250,000.

In non-limiting illustrative embodiments, as may be combined with one or more of the preceding paragraphs, the polyvinylpyrrolidone polymer has a weight average molecular weight of from about 30,000 to about 100,000.

In non-limiting illustrative embodiments, as may be combined with one or more of the preceding paragraphs, the one or more non-functionalized comfort polymers are present in the monomeric mixture in an amount of at least 6 wt. %, based on the total weight of the monomeric mixture.

In non-limiting illustrative embodiments, as may be combined with one or more of the preceding paragraphs, the one or more non-functionalized comfort polymers are present in the monomeric mixture in an amount ranging from 6 wt. % to about 10 wt. %, based on the total weight of the monomeric mixture.

In non-limiting illustrative embodiments, as may be combined with one or more of the preceding paragraphs, the monomeric mixture further comprises one or more functionalized comfort polymers.

In non-limiting illustrative embodiments, as may be combined with one or more of the preceding paragraphs, the one or more functionalized comfort polymers comprise one or more of a functionalized poloxamer and a functionalized poloxamine.

In non-limiting illustrative embodiments, as may be combined with one or more of the preceding paragraphs, the one or more functionalized comfort polymers comprise a functionalized poloxamer derived from a poloxamer block copolymer.

In non-limiting illustrative embodiments, as may be combined with one or more of the preceding paragraphs, the functionalized poloxamer is one or more of a poloxamer di(meth)acrylate and a reverse poloxamer di(meth)acrylate.

In non-limiting illustrative embodiments, as may be combined with one or more of the preceding paragraphs, the one or more functionalized comfort polymers are present in the monomeric mixture in an amount ranging from about 1 wt. % to about 10 wt. %, based on the total weight of the monomeric mixture.

In non-limiting illustrative embodiments, as may be combined with one or more of the preceding paragraphs, the monomeric mixture further comprises one or more ophthalmic device-forming silicone comonomers.

In non-limiting illustrative embodiments, as may be combined with one or more of the preceding paragraphs, the one or more ophthalmic device-forming silicone comonomers comprise a hydroxyl-containing silicone comonomer.

In non-limiting illustrative embodiments, as may be combined with one or more of the preceding paragraphs, the hydroxyl-containing silicone comonomer comprises (3-methacryloxy-2-hydroxy propoxy)propyl bis(trimethyl siloxy)methyl silane.

In non-limiting illustrative embodiments, as may be combined with one or more of the preceding paragraphs, the one or more ophthalmic device-forming silicone comonomers comprise one or more bulky silicone comonomers.

In non-limiting illustrative embodiments, as may be combined with one or more of the preceding paragraphs, the one or more bulky silicone comonomers comprise one or more bulky silicone-containing comonomers represented by a structure of Formula II:

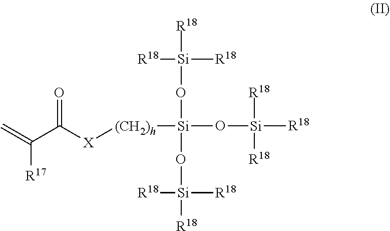

wherein X denotes —O— or —NR¹⁹—, wherein R¹⁹ is hydrogen or a C₁-C₄ alkyl group; each R¹⁷ independently denotes hydrogen or methyl; each R¹⁸ independently denotes a C₁-C₆ alkyl group, a phenyl group or a group represented by:

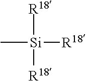

wherein each R^{18′} independently denotes a C₁-C₆ alkyl, or a phenyl radical; and h is 1 to 10, and of Formula III:

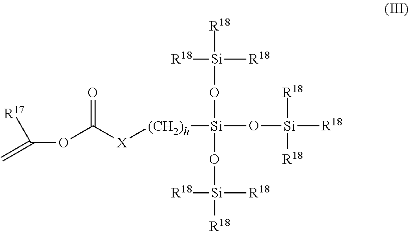

wherein X denotes —NR¹⁹—, wherein R¹⁹ denotes hydrogen or a C₁-C₄ alkyl group; R¹⁷ denotes hydrogen or methyl; each R¹⁸ independently denotes a C₁-C₆ alkyl group, a phenyl group or a group represented by:

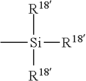

wherein each R^{18′} independently denotes a C₁-C₆ alkyl group, or a phenyl group; and h is 1 to 10.

In non-limiting illustrative embodiments, as may be combined with one or more of the preceding paragraphs, the one or more ophthalmic device-forming silicone comonomers are present in the monomeric mixture in an amount ranging from about 5 wt. % to about 50 wt. %, based on the total weight of the monomeric mixture.

In non-limiting illustrative embodiments, as may be combined with one or more of the preceding paragraphs, the monomeric mixture further comprises one or more of one or more crosslinking agents, one or more reactive ultraviolet light absorbers and one or more reactive blue-light absorbers.

In non-limiting illustrative embodiments, as may be combined with one or more of the preceding paragraphs, the ophthalmic device has an equilibrium water content of from about 35 wt. % to about 80 wt. %.

In non-limiting illustrative embodiments, as may be combined with one or more of the preceding paragraphs, the ophthalmic device is a silicon hydrogel having optical clarity.

According to yet another aspect of the disclosure, a method for making an ophthalmic device, comprises:
(a) curing a monomeric mixture in a mold, the monomeric mixture comprising:
(i) one or more monofunctional silicone monomers represented by a structure of Formula I:

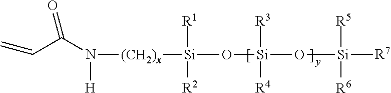

wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 5, and
(ii) one or more ophthalmic device-forming hydrophilic comonomers, and
(b) dry releasing the ophthalmic device from the mold.

In non-limiting illustrative embodiments, as may be combined with one or more of the preceding paragraphs, where in the monofunctional silicone monomer, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 5.

In non-limiting illustrative embodiments, as may be combined with one or more of the preceding paragraphs, where in the monofunctional silicone monomer, R¹, R², R³ and R⁴ are independently hydrogen, a C₁ to C₆ alkyl group; R⁵, R⁶ and R⁷ are independently a straight or branched C₁ to C₆ alkyl group; x is from 1 to 6; and y is from 3 to 5.

In non-limiting illustrative embodiments, as may be combined with one or more of the preceding paragraphs, where in the monofunctional silicone monomer, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 5.

In non-limiting illustrative embodiments, as may be combined with one or more of the preceding paragraphs, where in the monofunctional silicone monomer, R¹, R², R³, R⁴, R⁵ and R⁶ are methyl; R⁷ is a straight or branched C₃ to C₆ alkyl group; x is from 2 to 4; and y is from 3 to 5.

In non-limiting illustrative embodiments, as may be combined with one or more of the preceding paragraphs, the one or more ophthalmic device-forming hydrophilic comonomers are selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

In non-limiting illustrative embodiments, as may be combined with one or more of the preceding paragraphs, the one or more ophthalmic device-forming hydrophilic comonomers are selected from the group consisting of an acrylamide, a vinyl lactam and a hydroxyl-containing-(meth)acrylate.

In non-limiting illustrative embodiments, as may be combined with one or more of the preceding paragraphs, the acrylamide is one or more of N,N-dimethylacrylamide and N,N-dimethylmethacrylamide.

In non-limiting illustrative embodiments, as may be combined with one or more of the preceding paragraphs, the cyclic lactam is one or more of N-vinyl-2-pyrrolidone, N-vinyl caprolactam and N-vinyl-2-piperidone.

In non-limiting illustrative embodiments, as may be combined with one or more of the preceding paragraphs, the hydroxyl-containing (meth)acrylate is one or more of 2-hydroxyethyl methacrylate (HEMA) and glycerol methacrylate.

In non-limiting illustrative embodiments, as may be combined with one or more of the preceding paragraphs, the monomeric mixture comprises:

about 1 wt. % to about 40 wt. %, based on the total weight of the monomeric mixture, of the one or more monofunctional silicone monomers; and

about 10 wt. % to 80 wt. %, based on the total weight of the monomeric mixture, of the one or more ophthalmic device-forming hydrophilic comonomers.

In non-limiting illustrative embodiments, as may be combined with one or more of the preceding paragraphs, the monomeric mixture further comprises one or more non-functionalized comfort polymers.

In non-limiting illustrative embodiments, as may be combined with one or more of the preceding paragraphs, the one or more non-functionalized comfort polymers comprise a polyvinylpyrrolidone polymer.

In non-limiting illustrative embodiments, as may be combined with one or more of the preceding paragraphs, the polyvinylpyrrolidone polymer has a weight average molecular weight of at least about 10,000.

In non-limiting illustrative embodiments, as may be combined with one or more of the preceding paragraphs, the polyvinylpyrrolidone polymer has a weight average molecular weight of from about 10,000 to about 250,000.

In non-limiting illustrative embodiments, as may be combined with one or more of the preceding paragraphs, the polyvinylpyrrolidone polymer has a weight average molecular weight of from about 30,000 to about 100,000.

In non-limiting illustrative embodiments, as may be combined with one or more of the preceding paragraphs, the one or more non-functionalized comfort polymers are present in the monomeric mixture in an amount of at least 6 wt. %, based on the total weight of the monomeric mixture.

In non-limiting illustrative embodiments, as may be combined with one or more of the preceding paragraphs, the one or more non-functionalized comfort polymers are present in the monomeric mixture in an amount ranging from 6 wt. % to about 10 wt. %, based on the total weight of the monomeric mixture.

In non-limiting illustrative embodiments, as may be combined with one or more of the preceding paragraphs, the monomeric mixture further comprises one or more functionalized comfort polymers.

In non-limiting illustrative embodiments, as may be combined with one or more of the preceding paragraphs, the one or more functionalized comfort polymers comprise one or more of a functionalized poloxamer and a functionalized poloxamine.

In non-limiting illustrative embodiments, as may be combined with one or more of the preceding paragraphs, the one or more functionalized comfort polymers comprise a functionalized poloxamer derived from a poloxamer block copolymer.

In non-limiting illustrative embodiments, as may be combined with one or more of the preceding paragraphs, the functionalized poloxamer is one or more of a poloxamer di(meth)acrylate and a reverse poloxamer di(meth)acrylate.

In non-limiting illustrative embodiments, as may be combined with one or more of the preceding paragraphs, the one or more functionalized comfort polymers are present in the monomeric mixture in an amount ranging from about 1 wt. % to about 10 wt. %, based on the total weight of the monomeric mixture.

In non-limiting illustrative embodiments, as may be combined with one or more of the preceding paragraphs, the monomeric mixture further comprises one or more ophthalmic device-forming silicone comonomers.

In non-limiting illustrative embodiments, as may be combined with one or more of the preceding paragraphs, the one or more ophthalmic device-forming silicone comonomers comprise a hydroxyl-containing silicone comonomer.

In non-limiting illustrative embodiments, as may be combined with one or more of the preceding paragraphs, the hydroxyl-containing silicone comonomer comprises (3-methacryloxy-2-hydroxy propoxy)propyl bis(trimethyl siloxy)methyl silane.

In non-limiting illustrative embodiments, as may be combined with one or more of the preceding paragraphs, the one or more ophthalmic device-forming silicone comonomers comprises one or more bulky silicone comonomers.

In non-limiting illustrative embodiments, as may be combined with one or more of the preceding paragraphs, the one or more bulky silicone comonomers comprise one or more bulky silicone-containing comonomers represented by a structure of Formula II:

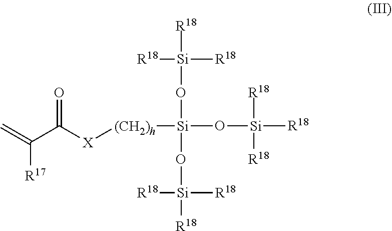

wherein X denotes —O— or —NR¹⁹—, wherein R¹⁹ is hydrogen or a C₁-C₄ alkyl group; each R¹⁷ independently denotes hydrogen or methyl; each R¹⁸ independently denotes a C₁-C₆ alkyl group, a phenyl group or a group represented by:

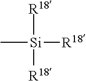

wherein each R^{18′} independently denotes a C₁-C₆ alkyl, or a phenyl radical; and h is 1 to 10, and of Formula III:

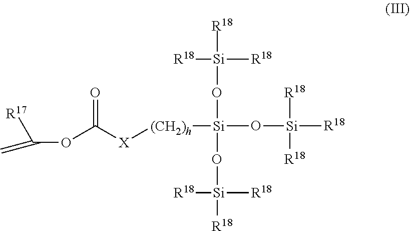

wherein X denotes —NR¹⁹—, wherein R¹⁹ denotes hydrogen or a C₁-C₄ alkyl group; R¹⁷ denotes hydrogen or methyl; each R¹⁸ independently denotes a C₁-C₆ alkyl group, a phenyl group or a group represented by:

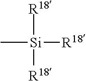

wherein each R^{18′} independently denotes a C₁-C₆ alkyl group, or a phenyl group; and h is 1 to 10.

In non-limiting illustrative embodiments, as may be combined with one or more of the preceding paragraphs, the one or more ophthalmic device-forming silicone comonomers are present in the monomeric mixture in an amount ranging from about 5 wt. % to about 50 wt. %, based on the total weight of the monomeric mixture.

In non-limiting illustrative embodiments, as may be combined with one or more of the preceding paragraphs, the monomeric mixture further comprises one or more of one or more crosslinking agents, one or more reactive ultraviolet light absorbers and one or more reactive blue-light absorbers.

In non-limiting illustrative embodiments, as may be combined with one or more of the preceding paragraphs, the ophthalmic device has an equilibrium water content of from about 35 wt. % to about 80 wt. %.

In non-limiting illustrative embodiments, as may be combined with one or more of the preceding paragraphs, the ophthalmic device is a silicon hydrogel having optical clarity.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A monofunctional silicone monomer represented by a structure of Formula I: 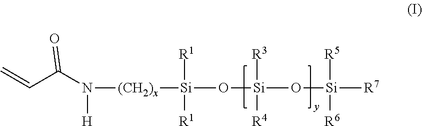
wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 5.

2. The monofunctional silicone monomer according to claim 1, wherein R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 5.

3. The monofunctional silicone monomer according to claim 1, wherein R¹, R², R³ and R⁴ are independently hydrogen, a C₁ to C₆ alkyl group; R⁵, R⁶ and R⁷ are independently a straight or branched C₁ to C₆ alkyl group; x is from 1 to 6; and y is from 3 to 5.

4. The monofunctional silicone monomer according to claim 1, wherein R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 5.

5. The monofunctional silicone monomer according to claim 1, wherein R¹, R², R³, R⁴, R⁵ and R⁶ are methyl; R⁷ is a straight or branched C₃ to C₆ alkyl group; x is from 2 to 4; and y is from 3 to 5.

6. An ophthalmic device which is a polymerization product of a monomeric mixture comprising:
(a) one or more monofunctional silicone monomers represented by a structure of Formula I: 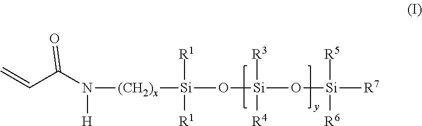
wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 5; and
(b) one or more ophthalmic device-forming hydrophilic comonomers.

7. The ophthalmic device according to claim 6, wherein in the monofunctional silicone monomer, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group; x is from 1 to 6; and y is from 3 to 5.

8. The ophthalmic device according to claim 6, wherein in the monofunctional silicone monomer, R¹, R², R³ and R⁴ are independently hydrogen, a C₁ to C₆ alkyl group; R⁵, R⁶ and R⁷ are independently a straight or branched C₁ to C₆ alkyl group; x is from 1 to 6; and y is from 3 to 5.

9. The ophthalmic device according to claim 6, wherein in the monofunctional silicone monomer, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group; x is from 2 to 4; and y is from 3 to 5.

10. The ophthalmic device according to claim 6, wherein in the monofunctional silicone monomer, R¹, R², R³, R⁴, R⁵ and R⁶ are methyl; R⁷ is a straight or branched C₃ to C₆ alkyl group; x is from 2 to 4; and y is from 3 to 5.

11. The ophthalmic device according to claim 6, wherein the one or more ophthalmic device-forming hydrophilic comonomers are selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

12. The ophthalmic device according to claim 6, wherein the monomeric mixture comprises:
about 1 wt. % to about 40 wt. %, based on the total weight of the monomeric mixture, of the one or more monofunctional silicone monomers; and
about 10 wt. % to 80 wt. %, based on the total weight of the monomeric mixture, of the one or more ophthalmic device-forming hydrophilic comonomers.

13. The ophthalmic device according to claim 6, wherein the monomeric mixture further comprises one or more non-functionalized comfort polymers.

14. The ophthalmic device according to claim 13, wherein the one or more non-functionalized comfort polymers comprise a polyvinylpyrrolidone polymer having a weight average molecular weight of at least about 10,000.

15. The ophthalmic device according to claim 13, wherein the one or more non-functionalized comfort polymers are present in the monomeric mixture in an amount of at least 6 wt. %, based on the total weight of the monomeric mixture.

16. The ophthalmic device according to claim 6, wherein the monomeric mixture further comprises one or more of one or more functionalized comfort polymers, one or more crosslinking agents, one or more reactive ultraviolet light absorbers and one or more reactive blue-light absorbers.

17. The ophthalmic device according to claim 6, wherein the monomeric mixture further comprises one or more ophthalmic device-forming silicone comonomers.

18. The ophthalmic device according to claim 6, having an equilibrium water content of from about 35 wt. % to about 80 wt. %.

19. The ophthalmic device according to claim 6, which is a silicon hydrogel having optical clarity.

20. A method for making an ophthalmic device, comprising:
(a) curing a monomeric mixture in a mold, the monomeric mixture comprising:
(i) one or more monofunctional silicone monomers represented by a structure of Formula I: 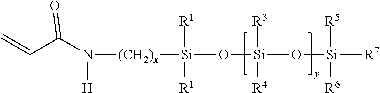
wherein R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; x is from 1 to 6; and y is from 3 to 5; and
(ii) one or more ophthalmic device-forming hydrophilic comonomers; and
(b) dry releasing the ophthalmic device from the mold.
